(19) United States
(12) Patent Application Publication
(10) Pub. No.: US 2023/0397247 A1
(43) Pub. Date: Dec. 7, 2023

(54) RANDOM ACCESS PROCEDURE IN A NON-TERRESTRIAL NETWORK

(71) Applicant: Lenovo (Singapore) Pte. Ltd., New Tech Park (SG)

(72) Inventors: Hyejung Jung, Northbrook, IL (US); Majid Ghanbarinejad, Chicago, IL (US); Vijay Nangia, Woodridge, IL (US)

(21) Appl. No.: 18/249,372

(22) PCT Filed: Oct. 15, 2021
(86) PCT No.: PCT/IB2021/059531

§ 371 Date: Apr. 17, 2023

Related U.S. Application Data
(60) Provisional application No. 63/092,415, filed on Oct. 15, 2020.

(51) Int. Cl. H04W 74/00; H04B 7/185; H04W 56/00; H04W 72/0446; H04W 72/1268; H04W 74/08; H04L 1/1829

(52) U.S. Cl. CPC H04W 74/004; H04B 7/18519; H04W 56/0045; H04W 84/06; H04W 72/1268; H04W 74/0833; H04L 1/1854; H04W 72/0446

(57) ABSTRACT

Apparatuses, methods, and systems are disclosed for random access procedure in a non-terrestrial network. One apparatus (500) includes a processor (505) that determines one or more transmission timings associated with a random access procedure, each transmission timing determined based on each transmission slot and a timing advance value for transmitting messages between the UE and a mobile wireless communication network, the mobile wireless communication network comprising a non-terrestrial network (“NTN”), each transmission slot determined by applying a configured slot offset, the configured slot offset applied to adjust for a round trip time within the NTN. An apparatus (500) includes a transceiver (525) that transmits one or more messages during the random access procedure based on the determined one or more transmission timings.

### CROSS-REFERENCE TO RELATED APPLICATIONS

This application claims priority to U.S. Provisional Patent Application No. 63/092,415 entitled “RANDOM ACCESS PROCEDURE IN NON-TERRESTRIAL NETWORK” and filed on Oct. 15, 2020, for Hyejung Jung, et al., which is incorporated herein by reference.

### FIELD

The subject matter disclosed herein relates generally to wireless communications and more particularly relates to random access procedure in a non-terrestrial network.

### BACKGROUND

In certain wireless communication systems, a User Equipment device (“UE”) is able to connect with a fifth-generation (“5G”) core network (i.e., “5GC”) in a Public Land Mobile Network (“PLMN”). In wireless networks, physical random access channel (“PRACH”) preamble formats are designed to handle a propagation delay. A timing advance (“TA”) command in a Random Access Response (“RAR”) can support the maximum TA value. In non-terrestrial networks, some UEs may be able to derive its position and/or a reference time and frequency based on its GNSS implementation compute timing and frequency offsets with respect to a network by using information signaled by the network and apply TA and frequency adjustment when transmitting a PRACH preamble.

### BRIEF SUMMARY

Disclosed are procedures for random access procedure in a non-terrestrial network. Said procedures may be implemented by apparatus, systems, methods, and/or computer program products.

In one embodiment, an apparatus includes a processor that determines one or more transmission timings associated with a random access procedure, each transmission timing determined based on each transmission slot and a timing advance value, for transmitting messages between the UE and a mobile wireless communication network, the mobile wireless communication network comprising a non-terrestrial network (“NTN”), each transmission slot determined by applying a configured slot offset, the configured slot offset applied to adjust for a round trip time within the NTN. In one embodiment, the apparatus includes a transceiver that transmits one or more messages during the random access procedure based on the determined one or more transmission timings.

In one embodiment, a method includes determining one or more transmission timings associated with a random access procedure, each transmission timing determined based on each transmission slot and a timing advance value, for transmitting messages between the UE and a mobile wireless communication network, the mobile wireless communication network comprising a non-terrestrial network (“NTN”), each transmission slot determined by applying a configured slot offset, the configured slot offset applied to adjust for a round trip time within the NTN. In one embodiment, the method includes transmitting one or more messages during the random access procedure based on the determined one or more transmission timings.

In one embodiment, another apparatus includes a processor that determines a slot offset, the slot offset applied to adjust for a round trip time within a mobile wireless communication network comprising a non-terrestrial network (“NTN”) and a transceiver that transmits the slot offset for communicating messages between a user equipment (“UE”) and a network equipment of the mobile wireless communication network. In one embodiment, the processor further determines one or more transmission timings associated with a random access procedure, each transmission timing determined based on each transmission slot and a timing advance value, each transmission slot determined by applying the slot offset the transceiver further receives one or more messages from the UE during the random access procedure based on the determined one or more transmission timings.

In one embodiment, another method includes determining a slot offset, the slot offset applied to adjust for a round trip time within a mobile wireless communication network comprising a non-terrestrial network (“NTN”), transmitting the slot offset for communicating messages between a user equipment (“UE”) and a network equipment of the mobile wireless communication network, determining one or more transmission timings associated with a random access procedure, each transmission timing determined based on each transmission slot and a timing advance value, each transmission slot determined by applying the slot offset, and receiving one or more messages from the UE during the random access procedure based on the determined one or more transmission timings.

In one embodiment, another apparatus includes a transceiver that receives a scheduling request (“SR”) configuration. In one embodiment, the apparatus includes a processor that identifies a SR resource based on the received SR configuration upon arrival of uplink data. In one embodiment, the uplink data is associated with the received SR configuration and the SR resource is an earliest available SR resource for a potential SR transmission with a timing advance after the arrival of the uplink data. In one embodiment, the processor determines whether to transmit a SR on the SR resource and initiates a random access procedure when determining not to transmit the SR on the SR resource. In one embodiment, the processor initiates the random access procedure while an uplink timing alignment timer at the UE is running.

In one embodiment, another method includes receiving a scheduling request (“SR”) configuration. In one embodiment, the method includes identifying a SR resource based on the received SR configuration upon arrival of uplink data. In one embodiment, the uplink data is associated with the received SR configuration and the SR resource is an earliest available SR resource for a potential SR transmission with a timing advance after the arrival of the uplink data. In one embodiment, the method includes determining whether to transmit a SR on the SR resource and initiates a random access procedure when determining not to transmit the SR on the SR resource. In one embodiment, the method includes initiating the random access procedure while an uplink timing alignment timer at the UE is running.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of a wireless communication system for random access procedure in a non-terrestrial network;

FIG. 1B is a schematic block diagram illustrating one embodiment of a wireless communication system for random access procedure in a non-terrestrial network

FIG. 2 depicts a SIB9 information element;

FIG. 3 depicts a RACH-ConfigCommon information element;

FIG. 4A depicts a timing relationship for SR occasion and expiry of an UL timing alignment timer;

FIG. 4B depicts PDCCH monitoring after PRACH transmission with a common TA;

FIG. 5 is a block diagram illustrating one embodiment of a user equipment apparatus that may be used for random access procedure in a non-terrestrial network;

FIG. 6 is a block diagram illustrating one embodiment of a network apparatus that may be used for random access procedure in a non-terrestrial network;

FIG. 7 is a flowchart diagram illustrating one embodiment of a method for random access procedure in a non-terrestrial network;

FIG. 8 is a flowchart diagram illustrating one embodiment of another method for random access procedure in a non-terrestrial network; and

FIG. 9 is a flowchart diagram illustrating one embodiment of another method for random access procedure in a non-terrestrial network.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for random access procedure in a non-terrestrial network. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In Rel-15/16 NR, a UE initiates a random access procedure upon UL data arrival during RRC_SONNECTED when UL synchronization status is “non-synchronized” and after SR failure. For PRACH preamble transmission, a UE sets a UE-specific timing advance value N_{TA} to be zero. A predefined or cell-specifically configured TA offset N_{TA,offset} is only a fraction of a slot duration. The UE can detect a PDCCH scheduling a RAR as early as one symbol after the last symbol of a PRACH occasion where the UE has transmitted a PRACH preamble.

In NTN, due to a long round trip time and accordingly a large TA value, a timeAlignmentTimer of a particular TAG may expire while a UE is waiting for an UL grant after transmitting a scheduling request. Early initiation of a random access procedure, continued monitoring of PDCCH in UE-specific search space, and adaptive monitoring of RAR can avoid potential long delay in UL data transmission.

In order to support new radio (“NR”) non-terrestrial networks (“NTNs”), especially networks that include low earth orbit (“LEO”) and geostationary earth orbit (“GEO”) components with implicit compatibility to support high altitude platform station (“HAPS”) and air-to-ground (“ATG”) scenarios, in one embodiment, the following principles are followed:
Frequency division duplex (“FDD”) is assumed for core specification work for NR-NTN.
   NOTE: This does not imply that time division duplex (“TDD”) cannot be used for relevant scenarios such as HAPS or ATG.
Earth fixed tracking area is assumed with Earth fixed and moving cells.
UEs with global navigation satellite system (“GNSS”) capabilities are assumed.
Transparent payload is assumed.

In one embodiment, some of the detailed objectives are to specify enhancing features to the NR radio interface and NG-RAN as follows:
Enhancing features to address the identified issues due to long propagation delays, large Doppler effects, and moving cells in NTN, the following should be specified:
   Timing relationship enhancements.
   Enhancements on UL time and frequency synchronization.
   Hybrid automatic repeat request (“HARQ”).
      Number of HARQ processes.
      Enabling/disabling of HARQ feedback.
In addition, the following topics should be specified if beneficial and needed
   Enhancement on the PRACH sequence and/or format and extension of the ra-ResponseWindow duration (e.g., in the case of a UE with GNSS capability but without pre-compensation of timing and frequency offset capabilities).
   Feeder link switch.
   Beam management and Bandwidth Parts (BWP) operation for NTN with frequency reuse.
      Including signaling of polarization mode.

Some of RAN2 related objectives are provided below:
MAC
   Random access:
      Definition of an offset for the start of the ra-ResponseWindow for NTN.
      Introduction of an offset for the start of the ra-ContentionResolutionTimer to resolve Random access contention.
      Solutions for resolving preamble ambiguity and extension of RAR window.
      Adaptation for Msg-3 scheduling.
      Only for the case with pre-compensation of timing and frequency offset at UE side).
   Enhancement on UL scheduling to reduce scheduling latency.
   DRX:
      If HARQ feedback is enabled, introduction of offset for drx-HARQ-RTT-TimerDL and drx-HARQ-RTT-TimerUL.
      If HARQ is turned off per HARQ process, adaptions in HARQ procedure.
   Scheduling Request: Extension of the value range of sr-ProhibitTimer.
Enhancement to existing measurement configurations to address absolute propagation delay difference between satellites (e.g., SMTC measurement gap adaptation to the SSB/CSI-RS measurement window).

Round Trip Time (“RTT”) in NTN can be much larger (e.g., 545 milliseconds for the round trip time between Gateway and UE via a Geostationary Earth Orbit (“GEO”) satellite at 35786 km) than RTT in terrestrial network. Thus, its impact on a random access procedure may need to be thoroughly investigated.

In one embodiment, this disclosure presents methods to determine when to initiate a random access procedure considering a longer RTT and related procedures in a Non-Terrestrial Network. Furthermore, in one embodiment, necessary changes in UE transmission timing during the random access procedure are identified and proposed.

In one embodiment, a UE in an RRC_CONNECTED state initiates a random access procedure for a potential expiry of an UL timing alignment timer upon arriving UL data or for a potential SR failure, if receiving an implicit or explicit indication(s) that a serving cell is an NTN cell and/or that an early initiation of a random access procedure is configured. The UE may further receive information of a timer value at which the UE initiates the random access procedure instead of transmitting a SR upon arriving UL data or with a pending SR.

In one embodiment, the UE with the early initiation of the random access procedure continues monitoring PDCCH on at least one configured PDCCH monitoring occasion of at least one UE-specific search space (“US S”) until a first time instance, where the first time instance can be configured such as a time instance earlier than or at a start of a RAR reception window, or when an UL timing alignment timer expires. The UE determines whether to start an RAR timer and monitor PDCCH within an RAR window, based on detected DCI formats in a time interval from a start of the PRACH transmission to the first time instance and/or based on a received configuration.

In one embodiment, timing for PRACH preamble retransmission, timing for Msg3 transmission, timing for HARQ-ACK feedback to MsgB successRAR, and PRACH preamble transmission timing in PDCCH-ordered random access procedure are determined considering a maximum TA value that can be applied to.

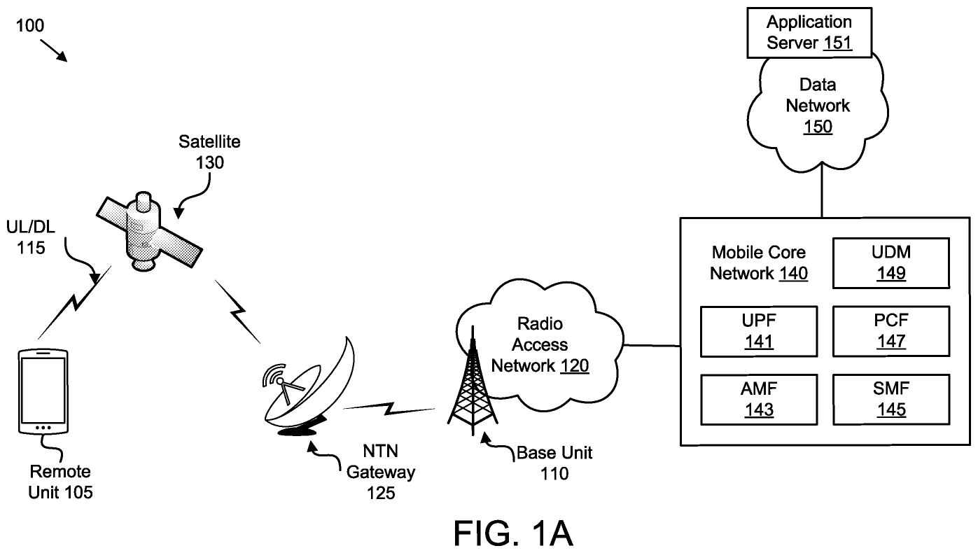

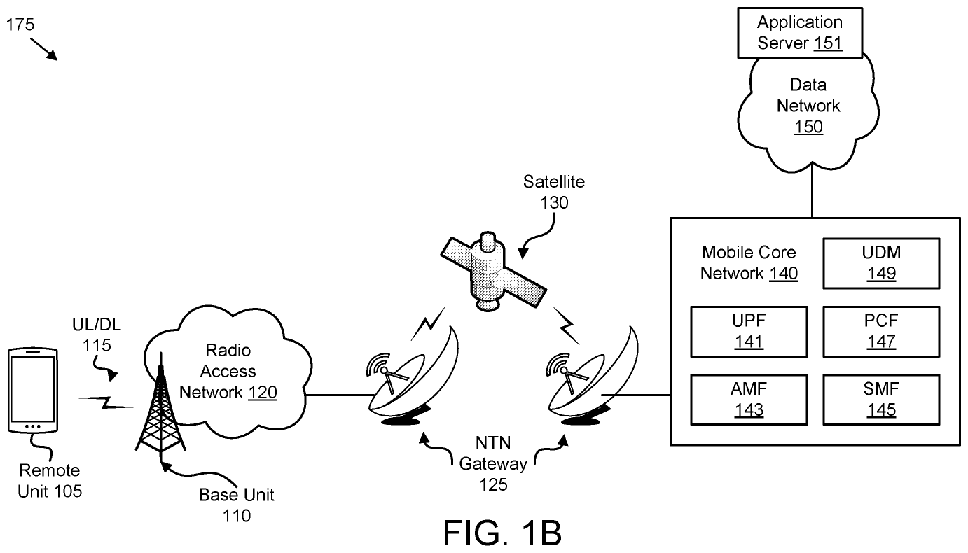

FIG. 1A depicts a wireless communication system 100 supporting random access procedure in non-terrestrial network, according to embodiments of the disclosure. In one embodiment, the wireless communication system 100 includes at least one remote unit 105, a radio access network (“RAN”) 120 (e.g., a NG-RAN), and a mobile core network 140. The RAN120 and the mobile core network 140 form a mobile communication network. The RAN120 may be composed of a base unit 110 with which the remote unit 105 communicates using wireless communication links 115. Even though a specific number of remote units 105, base units 110, wireless communication links 115, RANs 120, satellites 130, non-terrestrial network gateways 125 (e.g., satellite ground/earth devices), and mobile core networks 140 are depicted in FIG. 1, one of skill in the art will recognize that any number of remote units 105, base units 110, wireless communication links 115, RANs 120, satellites 130, non-terrestrial network gateways 125 (e.g., satellite ground/earth devices), and mobile core networks 140 may be included in the wireless communication system 100.

In one implementation, the RAN120 is compliant with the 5G system specified in the 3GPP specifications. In another implementation, the RAN120 is compliant with the LTE system specified in the 3GPP specifications. More generally, however, the wireless communication system 100 may implement some other open or proprietary communication network, for example WiMAX, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art.

The remote units 105 may communicate directly with the base units 110 in the RAN 120 via uplink (“UL”) and downlink (“DL”) communication signals. In some embodiments, the remote units 105 communicate in a non-terrestrial network via UL and DL communication signals between the remote unit 105 and a satellite 130. The satellite 130 may communicate with the RAN 120 via an NTN gateway 125 using UL and DL communication signals between the satellite 130 and the NTN gateway 125. The NTN gateway 125 may communicate directly with the base units 110 in the RAN120 via UL and DL communication signals. Furthermore, the UL and DL communication signals may be carried over the wireless communication links 115. Here, the RAN 120 is an intermediate network that provides the remote units 105 with access to the mobile core network 140.

In some embodiments, the remote units 105 communicate with an application server 151 via a network connection with the mobile core network 140. For example, an application 107 (e.g., web browser, media client, telephone/VoIP application) in a remote unit 105 may trigger the remote unit 105 to establish a PDU session (or other data connection) with the mobile core network 140 via the RAN120. The mobile core network 140 then relays traffic between the remote unit 105 and the application server 151 in the packet data network 150 using the PDU session. Note that the remote unit 105 may establish one or more PDU sessions (or other data connections) with the mobile core network 140. As such, the remote unit 105 may concurrently have at least one PDU session for communicating with the packet data network 150 and at least one PDU session for communicating with another data network (not shown).

The base units 110 may be distributed over a geographic region. In certain embodiments, a base unit 110 may also be referred to as an access terminal, an access point, a base, a base station, a Node-B, an eNB, a gNB, a Home Node-B, a relay node, a RAN node, or by any other terminology used in the art. The base units 110 are generally part of a radio access network (“RAN”), such as the RAN120, that may include one or more controllers communicably coupled to one or more corresponding base units 110. These and other elements of radio access network are not illustrated but are well known generally by those having ordinary skill in the art. The base units 110 connect to the mobile core network 140 via the RAN120.

The base units 110 may serve a number of remote units 105 within a serving area, for example, a cell or a cell sector, via a wireless communication link 115. The base units 110 may communicate directly with one or more of the remote units 105 via communication signals. Generally, the base units 110 transmit DL communication signals to serve the remote units 105 in the time, frequency, and/or spatial domain. Furthermore, the DL communication signals may be carried over the wireless communication links 115. The wireless communication links 115 may be any suitable carrier in licensed or unlicensed radio spectrum. The wireless communication links 115 facilitate communication between one or more of the remote units 105 and/or one or more of the base units 110. Note that during NR-U operation, the base unit 110 and the remote unit 105 communicate over unlicensed radio spectrum.

In one embodiment, the mobile core network 140 is a 5G core (“5GC”) or the evolved packet core (“EPC”), which may be coupled to a packet data network 150, like the Internet and private data networks, among other data networks. A remote unit 105 may have a subscription or other account with the mobile core network 140. Each mobile core network 140 belongs to a single public land mobile network (“PLMN”). The present disclosure is not intended to be limited to the implementation of any particular wireless communication system architecture or protocol.

The mobile core network 140 includes several network functions (“NFs”). As depicted, the mobile core network 140 includes multiple user plane functions (“UPFs”) 141. The mobile core network 140 also includes multiple control plane functions including, but not limited to, an Access and Mobility Management Function (“AMF”) 143 that serves the RAN120, a Session Management Function (“SMF”) 145, a Policy Control Function (“PCF”) 147, and a Unified Data Management function (“UDM”) 149.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. A network instance may be identified by a S-NSSAI, while a set of network slices for which the remote unit 105 is authorized to use is identified by NSSAI. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

Although specific numbers and types of network functions are depicted in FIG. 1A, one of skill in the art will recognize that any number and type of network functions may be included in the mobile core network 140. Moreover, where the mobile core network 140 is an EPC, the depicted network functions may be replaced with appropriate EPC entities, such as an MME, S-GW, P-GW, HSS, and the like. In certain embodiments, the mobile core network 140 may include a AAA server.

While FIG. 1A depicts components of a 5G RAN and a 5G core network, the described embodiments apply to other types of communication networks and RATs, including IEEE 802.11 variants, GSM, GPRS, UMTS, LTE variants, CDMA 2000, Bluetooth, ZigBee, Sigfoxx, and the like. For example, in an LTE variant involving an EPC, the AMF may be mapped to an MME, the SMF mapped to a control plane portion of a PGW and/or to an MME, the UPF map to an SGW and a user plane portion of the PGW, the UDM/UDR maps to an HSS, etc.

In the following descriptions, the term “gNB” is used for the base station but it is replaceable by any other radio access node, e.g., RAN node, eNB, BS, eNB, gNB, AP, NR, etc. Further the operations are described mainly in the context of 5G NR. However, the proposed solutions/methods are also equally applicable to other mobile communication systems supporting timing and frequency adjustments in non-terrestrial networks.

FIG. 1B depicts another wireless communication system 175 supporting random access procedure in non-terrestrial network, according to embodiments of the disclosure. FIG. 1B, in one embodiment, is substantially similar to the non-terrestrial network 100 depicted in FIG. 1A. In FIG. 1B, a remote unit 105 communicates directly with the base units 110 in the RAN120 via uplink (“UL”) and downlink (“DL”) communication signals over wireless communication links 115. In an embodiment of a non-terrestrial network, the RAN120 may communicate with a mobile core network 140 via an NTN gateway 125, which may be directly connected to the RAN120, that communicates with a satellite 130. The satellite 130, in further embodiments, communicates with another NTN gateway 125 that is directly connected to the mobile core network 140.

In NR, in one embodiment, physical random access channel (“PRACH”) preamble formats are designed to handle a propagation delay for approximately up to a 200 km distance and equivalently a round trip delay for up to 100 km distance (based on the maximum PRACH cyclic prefix length of (20124×64×Tc), where Tc is defined in Subclause 4.1 of TS 38.211). A timing advance (“TA”) command in a random access response (“RAR”), in one embodiment, can support the maximum TA value (3846×16×64×Tc) corresponding to compensating a round trip time for a 300 km link distance.

In NR, in one embodiment, for PRACH preamble transmission, a UE sets a UE-specific timing advance value N_{TA} to be zero. That is, a PRACH preamble transmission timing is N_{TA,offset}·T_{c} ahead of a corresponding downlink (“DL”) timing, where N_{TA,offset} is a predefined TA offset based on a duplex mode and a frequency range of a serving cell or is a cell-specifically configured TA offset. In one embodiment, the value options for the RRC signaled N_{TA,offset} (e.g., the RRC parameter n-TimingAdvanceOffset) are 0, 25600, and 39936, which correspond to 0, 13 μs, and 20 μs, respectively. In one embodiment, the predefined value options for the N_{TA,offset} are 0, 25600, and 39936 (corresponding to 0, 13 μs, and 20 μs, respectively) in FR1 and 13792 (corresponding to 7 μs) in FR2. These TA offset durations may only be fractions of a slot duration (e.g., 1 ms, 0.5 ms, 0.25 ms, and 0.125 ms for subcarrier spacing of 15 KHz, 30 KHz, 60 KHz, and 120 KHz, respectively). Further, in one embodiment, the UE can detect a PDCCH scheduling a RAR as early as one symbol after the last symbol of a PRACH occasion where the UE has transmitted a PRACH preamble.

In NR-NTN, in one embodiment, some UEs may be able to derive its position and/or a reference time and frequency based on its GNSS implementation. Further, the UEs may be able to compute timing and frequency offsets with respect to a network by using information (e.g., serving satellite ephemeris or timestamp) signaled by the network and apply TA and frequency adjustment when transmitting a PRACH preamble(s). In case of GNSS-assisted TA acquisition in RRC idle/inactive mode, the UE may calculate its UE-specific TA 1) based on its GNSS acquired position together with the serving satellite ephemeris indicated by the network or 2) based on the GNSS acquired reference time at UE together with reference time as indicated by the network.

Alternatively, a common TA to compensate a common propagation delay for all served UEs in a cell may be indicated by the network and may be applied to a PRACH preamble transmission(s) by the UEs. In this case, any uncompensated residual propagation delay of a particular UE may be identified from the received PRACH preamble(s) by the network. Accordingly, uplink transmit timing for subsequent uplink transmissions by the particular UE may be adjusted during the random access procedure.

The following disclosure presents 3GPP NR specifications regarding PRACH preamble formats, UE transmission timing adjustment including timing adjustment delay, PDCCH monitoring in link recovery procedure, PRACH preamble transmission timing in a PDCCH-ordered random access procedure, PRACH preamble re-transmission timing, Msg3 transmission timing, and MsgB HARQ-ACK feedback timing.

In general, throughout this disclosure, unless otherwise noted, the size of various fields in the time domain is expressed in time units T_{c}=1/(Δfₘₐₓ·N_{f}) where Δfₘₐₓ=480·10³ Hz and N_{f}=4096. The constant k=Tₛ/T_{c}=64 where Tₛ=1/(Δf_{ref}·N_{f,ref}) Δf_{ref}=15·10³ Hz and N_{f,ref}=2048.

Throughout this disclosure, unless otherwise noted, statements using the term “UE” are equally applicable to the IAB-MT part of an IAB-node.

Regarding frames and subframes, in one embodiment, downlink, uplink, and sidelink transmissions are organized into frames with T_{f}=(ΔfₘₐₓN_{f}/100)·T_{c}=10 ms duration, each consisting of ten subframes of T_{sf}=(ΔfₘₐₓN_{f}/1000)·T_{c}=1 ms duration. In one embodiment, the number of consecutive OFDM symbols per subframe is N_{symb}^{subframe,μ}=N_{symb}^{subframe,μ}. Each frame may be divided into two equally-sized half-frames of five subframes each with half-frame 0 consisting of subframes 0-4 and half-frame 1 consisting of subframes 5-9.

In one embodiment, there is one set of frames in the uplink and one set of frames in the downlink on a carrier. Uplink frame number i for transmission from the UE shall start T_{TA}(N_{TA}+N_{TA,offset})T_{c} before the start of the corresponding downlink frame at the UE where N_{TA,offset} is given by e.g., 3GPP TS 38.214, except for msgA transmission on PUSCH where N_{TA}=0 shall be used.

Regarding physical random-access channel, for sequence generation, the set of random-access preambles x_{u,v}(n) may be generated according to

$${x}_{u , v} ( n ) = {x}_{u} ( ( n + {C}_{v} ) mod {L}_{R A} )$$

$${x}_{u} ( i ) = {e}^{- j \frac{π ui ( i + 1 )}{{L}_{RA}}} , i = 0 , 1 , … , {L}_{RA} - 1$$

from which the frequency-domain representation shall be generated according to

$${y}_{u , v} ( n ) = {\sum }_{m = 0}^{{L}_{R A} - 1} {x}_{u , v} ( m ) \cdot {e}^{- j \frac{2 π mn}{{L}_{R A}}}$$

where

$${L}_{R A} = 839 , \text{?} 139 ,$$

$$\text{?} \text{indicates text missing or illegible when filed}$$

L_{RA}=1151, or L_{RA}=571 depending on the PRACH preamble format.

In one embodiment, there are 64 preambles defined in each time-frequency PRACH occasion, enumerated in increasing order of first increasing cyclic shift c v of a logical root sequence, and then in increasing order of the logical root sequence index, starting with the index obtained from the higher-layer parameter prach-RootSequencelndex or rootSequencelndex-BFR or by msgA-PRACH-RootSequencelndex if configured and a type-2 random-access procedure is initiated, e.g., as described in clause 8.1 of 3GPP TS 38.214. In one embodiment, additional preamble sequences, in case 64 preambles cannot be generated from a single root Zadoff-Chu sequence, are obtained from the root sequences with the consecutive logical indexes until all the 64 sequences are found. The logical root sequence order may be cyclic; the logical index 0 is consecutive to L_{RA}−2. The sequence number u may be obtained from the logical root sequence index according to the table below.

TABLE 1
PRACH preamble formats for L_{RA} = 839 and Δf^{RA} ϵ {1.25, 5} kHz.

| | | | | | Support for |
|---|---|---|---|---|---|
| Format | L_{RA} | Δf ^{RA} | Nᵤ | N_{CP}^{RA} | restricted sets |
| 0 | 839 | 1.25 kHz | 24576 K | 3168 K | Type A, Type B |
| 1 | 839 | 1.25 kHz | 2 · 24576 K | 21024 K | Type A, Type B |
| 2 | 839 | 1.25 kHz | 4 · 24576 K | 4688 K | Type A, Type B |
| 3 | 839 | 5 kHz | 4 · 6144 K | 3168 K | Type A, Type B |

Regarding transmission timing adjustments, in one embodiment, a UE can be provided a value N_{TA,offset} of a timing advance offset for a serving cell by n-TimingAdvanceOffset for the serving cell. In one embodiment, if the UE is not provided n-TimingAdvanceOffset for a serving cell, the UE determines a default value N_{TA,offset} of the timing advance offset for the serving cell, e.g., as described in 3GPP TS 38.133.

In one embodiment, if a UE is configured with two UL carriers for a serving cell, a same timing advance offset value N_{TA,offset} applies to both carriers.

Upon reception of a timing advance command for a TAG, in one embodiment, the UE adjusts uplink timing for PUSCH/SRS/PUCCH transmission on all the serving cells in the TAG based on a value N_{TA,offset} that the UE expects to be same for all the serving cells in the TAG and based on the received timing advance command where the uplink timing for PUSCH/SRS/PUCCH transmissions is the same for all the serving cells in the TAG.

For a band with synchronous contiguous intra-band EN-DC in a band combination with non-applicable maximum transmit timing difference requirements, e.g., as described in Note 1 of Table 7.5.3-1 of 3GPP TS 38.133, in one embodiment, if the UE indicates ul-TimingAlignmentEUTRA-NR as ‘required’ and uplink transmission timing based on timing adjustment indication for a TAG from MCG and a TAG from SCG are determined to be different by the UE, the UE adjusts the transmission timing for PUSCH/SRS/PUCCH transmission on all serving cells part of the band with the synchronous contiguous intra-band EN-DC based on timing adjustment indication for a TAG from a serving cell in MCG in the band. The UE, in one embodiment, is not expected to transmit a PUSCH/SRS/PUCCH in one CG when the PUSCH/SRS/PUCCH is overlapping in time, even partially, with random access preamble transmitted in another CG.

For an SCS of 2^{μ}·15 kHz, in one embodiment, the timing advance command for a TAG indicates the change of the uplink timing relative to the current uplink timing for the TAG in multiples of 16·64·T_{c}/2^{μ}. The start timing of the random access preamble, for example, may be described in 3GPP TS 38.211.

In case of random access response, in one embodiment, a timing advance command, e.g., as described in 3GPP TS 38.321, T_{A}, for a TAG indicates N_{TA} values by index values of T_{A}=0, 1, 2, . . . , 3846, where an amount of the time alignment for the TAG with SCS of 2^{μ}·15 kHz is N_{TA}=T_{A}·16·64/2^{μ}. N_{TA}, for example, may be defined in 3GPP 38.211 and is relative to the SCS of the first uplink transmission from the UE after the reception of the random access response.

In other cases, in one embodiment, a timing advance command, e.g., as described in 3GPP TS 38.321, T_{A}, for a TAG indicates adjustment of a current N_{TA} value, N_{TA_old}, to the new N_{TA} value, N_{TA_new}, by index values of T_{A}=0, 1, 2, . . . , 63, where for a SCS of 2^{μ}·15 kHz, N_{TA_new}=N_{TA_old}+(T_{A}−31)·16·64/2^{μ}.

If a UE has multiple active UL BWPs, in one embodiment, in a same TAG, including UL BWPs in two UL carriers of a serving cell, the timing advance command value is relative to the largest SCS of the multiple active UL BWPs. The applicable N_{TA_new} value for an UL BWP with lower SCS, in one embodiment, may be rounded to align with the timing advance granularity for the UL BWP with the lower SCS while satisfying timing advance accuracy requirements, e.g., described in 3GPP TS 38.133.

Adjustment of an N_{TA} value by a positive or a negative amount, in one embodiment, indicates advancing or delaying the uplink transmission timing for the TAG by a corresponding amount, respectively.

For a timing advance command received on uplink slot n and for a transmission other than a PUSCH scheduled by a RAR UL grant or a fallbackRAR UL grant, or a PUCCH with HARQ-ACK information in response to a successRAR, in one embodiment, the corresponding adjustment of the uplink transmission timing applies from the beginning of uplink slot n+k+1 where k=┌Nₛₗₒₜ^{subframe,μ}·(N_{T,1}+N_{T,2}+N_{TA,max}+0.5)/T_{sf}┐, N_{T,1} is a time duration in msec of N₁ symbols corresponding to a PDSCH processing time for UE processing capability 1 when additional PDSCH DM-RS is configured, N_{T,2} is a time duration in msec of N₂ symbols corresponding to a PUSCH preparation time for UE processing capability 1, e.g., described in 3GPP TS 38.214, N_{TA,max} is the maximum timing advance value in msec that can be provided by a TA command field of 12 bits, Nₛₗₒₜ^{subframe,μ} is the number of slots per subframe, and T_{sf}, is the subframe duration of 1 msec. N₁ and N₂ are determined with respect to the minimum SCS among the SCSs of all configured UL BWPs for all uplink carriers in the TAG and of all configured DL BWPs for the corresponding downlink carriers.

For μ=0, in one embodiment, the UE assumes N_{1,0}=14, described in 3GPP TS 38.214. Slot n and Nₛₗₒₜ^{subframe,μ} may be determined with respect to the minimum SCS among the SCSs of all configured UL BWPs for all uplink carriers in the TAG. N_{TA,max} may be determined with respect to the minimum SCS among the SCSs of all configured UL BWPs for all uplink carriers in the TAG and for all configured initial UL BWPs provided by initialUplinkBWP. The uplink slot n, in one embodiment, is the last slot among uplink slot(s) overlapping with the slot(s) of PDSCH reception assuming T_{TA}=0, where the PDSCH provides the timing advance command and T_{TA} is defined e.g., in 3GPP 38.211.

If a UE changes an active UL BWP between a time of a timing advance command reception and a time of applying a corresponding adjustment for the uplink transmission timing, in one embodiment, the UE determines the timing advance command value based on the SCS of the new active UL BWP. If the UE changes an active UL BWP after applying an adjustment for the uplink transmission timing, in one embodiment, the UE assumes a same absolute timing advance command value before and after the active UL BWP change.

If the received downlink timing changes and is not compensated or is only partly compensated by the uplink timing adjustment without timing advance command, e.g., as described in 3GPP TS 38.133, in one embodiment, the UE changes N_{TA} accordingly. If two adjacent slots overlap due to a TA command, in one embodiment, the latter slot is reduced in duration relative to the former slot.

Regarding link recovery procedures, for the PCell or the PSCell, a UE can be provided a CORESET through a link to a search space set provided by recoverySearchSpaceId, in one embodiment, for monitoring PDCCH in the CORESET. If the UE is provided recoverySearchSpaceId, in one embodiment, the UE does not expect to be provided another search space set for monitoring PDCCH in the CORESET associated with the search space set provided by recoverySearchSpaceId.

For the PCell or the PSCell, in one embodiment, the UE can be provided, by PRACH-ResourceDedicatedBFR, a configuration for PRACH transmission, e.g., as described in Clause 8.1 of 3GPP TS 38.321. For PRACH transmission in slot n and according to antenna port quasi co-location parameters associated with periodic CSI-RS resource configuration or with SS/PBCH block associated with index q new provided by higher layers, e.g., described in 3GPP TS 38.321, the UE monitors PDCCH in a search space set provided by recoverySearchSpaceId for detection of a DCI format with CRC scrambled by C-RNTI or MCS-C-RNTI starting from slot n+4 within a window configured by BeamFailureRecoveryConfig.

For PDCCH monitoring in a search space set provided by recoverySearchSpaceId and for corresponding PDSCH reception, in one embodiment, the UE assumes the same antenna port quasi-collocation parameters as the ones associated with index q new until the UE receives by higher layers an activation for a TCI state or any of the parameters tci-StatesPDCCH-ToAddList and/or tci-StatesPDCCH-ToReleaseList. After the UE detects a DCI format with CRC scrambled by C-RNTI or MCS-C-RNTI in the search space set provided by recoverySearchSpaceId, in one embodiment, the UE continues to monitor PDCCH candidates in the search space set provided by recoverySearchSpaceId until the UE receives a MAC CE activation command for a TCI state or tci-StatesPDCCH-ToAddList and/or tci-StatesPDCCH-ToReleaseList.

For the PCell or the PSCell, in one embodiment, after 28 symbols from a last symbol of a first PDCCH reception in a search space set provided by recoverySearchSpaceId for which the UE detects a DCI format with CRC scrambled by C-RNTI or MCS-C-RNTI and until the UE receives an activation command for PUCCH-SpatialRelationInfo, e.g., as described in 3GPP TS 38.321, or is provided PUCCH-SpatialRelationInfo for PUCCH resource(s), the UE transmits a PUCCH on a same cell as the PRACH transmission using a same spatial filter as for the last PRACH transmission and/or a power determined with qᵤ=0, q_{d}=q_{new}, and l=0.

For the PCell or the PSCell, in one embodiment, after 28 symbols from a last symbol of a first PDCCH reception in a search space set provided by recoverySearchSpaceId where a UE detects a DCI format with CRC scrambled by C-RNTI or MCS-C-RNTI, the UE assumes same antenna port quasi-collocation parameters as the ones associated with index q new for PDCCH monitoring in a CORESET with index 0.

A UE, in one embodiment, can be provided, by schedulingRequestID-BFR-SCell-r16, a configuration for PUCCH transmission with a link recovery request (“LRR”). The UE can transmit in a first PUSCH MAC CE providing index(es) for at least corresponding SCell(s) with radio link quality worse than Q_{out,LR}, indication(s) of presence of q_{new}, for corresponding SCell(s), and index(es) q_{new}, for a periodic CSI-RS configuration or for a SS/PBCH block provided by higher layers, e.g., as described in 3GPP TS 38.321, if any, for corresponding SCell(s). In one embodiment, after 28 symbols from a last symbol of a PDCCH reception with a DCI format scheduling a PUSCH transmission with a same HARQ process number as for the transmission of the first PUSCH and having a toggled NDI field value, the UE:
to monitors PDCCH in all CORESETs on the SCell(s) indicated by the MAC CE using the same antenna port quasi co-location parameters as the ones associated with the corresponding index(es) q_{new}, if any;
transmits PUCCH on a PUCCH-SCell using a same spatial domain filter as the one corresponding to q_{new}, for periodic CSI-RS or SS/PBCH block reception, as described in Clause 9.2.2, and using a power determined as described in Clause 7.2.1 with qᵤ=0, q_{d}=q_{new}, and l=0, if
   the UE is provided PUCCH-SpatialRelationlnfo for the PUCCH;
   a PUCCH with the LRR was either not transmitted or was transmitted on the PCell or the PSCell; and
   the PUCCH-SCell is included in the SCell(s) indicated by the MAC-CE

where the SCS configuration for the 28 symbols is the smallest of the SCS configurations of the active DL BWP for the PDCCH reception and of the active DL BWP(s) of the at least one SCell.

Regarding random access preamble, in one embodiment, for paired spectrum or supplementary uplink band all PRACH occasions are valid.

For unpaired spectrum, in one embodiment, if a UE is not provided tdd-UL-DL-ConfigurationCommon, a PRACH occasion in a PRACH slot is valid if it does not precede a SS/PBCH block in the PRACH slot and starts at least N_{gap} symbols after a last SS/PBCH block reception symbol, and, if ChannelAccessMode-r16=semistatic is provided, does not overlap with a set of consecutive symbols before the start of a next channel occupancy time where the UE does not transmit, e.g., as described in 3GPP TS 37.213.

In one embodiment, the candidate SS/PBCH block index of the SS/PBCH block corresponds to the SS/PBCH block index provided by ssb-PositionslnBurst in SIB1 or in ServingCellConfigCommon.

In one embodiment, if a UE is provided tdd-UL-DL-ConfigurationCommon, a PRACH occasion in a PRACH slot is valid if it is within UL symbols or it does not precede a SS/PBCH block in the PRACH slot and starts at least N_{gap} symbols after a last downlink symbol and at least N_{gap} symbols after a last SS/PBCH block symbol, where N_{gap} is provided in the Table below, and if ChannelAccessMode-r16=semistatic is provided, does not overlap with a set of consecutive symbols before the start of a next channel occupancy time where there shall not be any transmissions, e.g., as described in 3GPP TS 37.213. In one embodiment, the candidate SS/PBCH block index of the SS/PBCH block corresponds to the SS/PBCH block index provided by ssb-PositionsInBurst in SIB1 or in ServingCellConfigCommon. For preamble format B4, e.g., as described in 3GPP TS 38.211, N_{gap}=0.

TABLE 2
N_{gap} values for different preamble SCS μ

| Preamble SCS | N_{gap} |
|---|---|
| 1.25 kHz or 5 kHz | 0 |
| 15 kHz or 30 kHz or 60 kHz or | 2 |
| 120 kHz | |

In one embodiment, if a random access procedure is initiated by a PDCCH order, the UE, if requested by higher layers, transmits a PRACH in the selected PRACH occasion, e.g., as described in 3GPP TS 38.321, for which a time between the last symbol of the PDCCH order reception and the first symbol of the PRACH transmission is larger than or equal to N_{T,2}+Δ_{BWPSwitching}+Δ_{Delay}+T_{switch} msec, where:
N_{T,2} is a time duration of N₂ symbols corresponding to a PUSCH preparation time for UE processing capability 1, e.g., as described in 3GPP TS 38.214, assuming μ corresponds to the smallest SCS configuration between the SCS configuration of the PDCCH order and the SCS configuration of the corresponding PRACH transmission;
Δ_{BWPSwitching}=0 if the active UL BWP does not change and Δ_{BWPSwitching} is defined, e.g., in 3GPP TS 38.133, otherwise;
Δ_{Delay}=0.5 msec for FR1 and Δ_{Delay}=0.25 msec for FR2; and
T_{switch} is a switching gap duration, e.g., as defined in 3GPP TS 38.214.

In one embodiment, for a PRACH transmission using 1.25 kHz or 5 kHz SCS, the UE determines N₂ assuming SCS configuration μ=0.

For single cell operation or for operation with carrier aggregation in a same frequency band, in one embodiment, a UE does not transmit PRACH and PUSCH/PUCCH/SRS in a same slot or when a gap between the first or last symbol of a PRACH transmission in a first slot is separated by less than N symbols from the last or first symbol, respectively, of a PUSCH/PUCCH/SRS transmission in a second slot where N=2 for μ=0 or μ=1, N=4 for μ=2 or μ=3, and μ is the SCS configuration for the active UL BWP. For a PUSCH transmission with repetition Type B, in one embodiment, this applies to each actual repetition for PUSCH transmission, e.g., described in 3GPP TS 38.214.

In one embodiment, a PUSCH occasion is valid if it does not overlap in time and frequency with any PRACH occasion associated with either a Type-1 random access procedure or a Type-2 random access procedure. Additionally, for unpaired spectrum and for SS/PBCH blocks with indexes provided by ssb-PositionsInBurst in SIB1 or by ServingCellConfigCommon, (1) if a UE is not provided tdd-UL-DL-ConfigurationCommon, a PUSCH occasion is valid if the PUSCH occasion does not precede a SS/PBCH block in the PUSCH slot, and starts at least N_{gap} symbols after a last SS/PBCH block symbol, (2) if a UE is provided tdd-UL-DL-ConfigurationCommon, a PUSCH occasion is valid if the PUSCH occasion is within UL symbols, or does not precede a SS/PBCH block in the PUSCH slot, and starts at least N_{gap} symbols after a last downlink symbol and at least N_{gap} symbols after a last SS/PBCH block symbol, where N_{gap} is provided in Table 8.1-2 and, if ChannelAccessMode-r16=semistatic is provided, does not overlap with a set of consecutive symbols before the start of a next channel occupancy time where the UE does not transmit, e.g., described in 3GPP TS 37.213.

In response to a PRACH transmission, in one embodiment, a UE attempts to detect a DCI format 1_0 with CRC scrambled by a corresponding RA-RNTI during a window controlled by higher layers, e.g., described in 3GPP TS 38.321. The window starts at the first symbol of the earliest CORESET the UE is configured to receive PDCCH for Type1-PDCCH CSS set that is at least one symbol, after the last symbol of the PRACH occasion corresponding to the PRACH transmission, where the symbol duration corresponds to the SCS for Type1-PDCCH CSS set. The length of the window in number of slots, based on the SCS for Type1-PDCCH CSS set, is provided by ra-Response Window.

In one embodiment, if the UE detects the DCI format 1_0 with CRC scrambled by the corresponding RA-RNTI and LSBs of a SFN field in the DCI format 1_0, if included and applicable, are same as corresponding LSBs of the SFN where the UE transmitted PRACH, and the UE receives a transport block in a corresponding PDSCH within the window, the UE passes the transport block to higher layers. The higher layers, in one embodiment, parse the transport block for a random access preamble identity (“RAPID”) associated with the PRACH transmission. If the higher layers identify the RAPID in RAR message(s) of the transport block, the higher layers indicate an uplink grant to the physical layer. This is referred to as random access response (“RAR”) UL grant in the physical layer.

In one embodiment, if the UE does not detect the DCI format 1_0 with CRC scrambled by the corresponding RA-RNTI within the window, or if the UE detects the DCI format 1_0 with CRC scrambled by the corresponding RA-RNTI within the window and LSBs of a SFN field in the DCI format 1_0, if included and applicable, are not same as corresponding LSBs of the SFN where the UE transmitted PRACH, or if the UE does not correctly receive the transport block in the corresponding PDSCH within the window, or if the higher layers do not identify the RAPID associated with the PRACH transmission from the UE, the higher layers can indicate to the physical layer to transmit a PRACH.

If requested by higher layers, in one embodiment, the UE is expected to transmit a PRACH no later than N_{T,1}+0.75 msec after the last symbol of the window, or the last symbol of the PDSCH reception, where N_{T,1} is a time duration of N₁ symbols corresponding to a PDSCH processing time for UE processing capability 1 assuming μ corresponds to the smallest SCS configuration among the SCS configurations for the PDCCH carrying the DCI format 1_0, the corresponding PDSCH when additional PDSCH DM-RS is configured, and the corresponding PRACH. For μ=0, the UE assumes N_{1,0}=14, e.g., described in 3GPP TS 38.214. For a PRACH transmission using 1.25 kHz or 5 kHz SCS, the UE determines N₁ assuming SCS configuration μ=0.

In one embodiment, in response to a transmission of a PRACH and a PUSCH, or to a transmission of only a PRACH if the PRACH preamble is mapped to a valid PUSCH occasion, a UE attempts to detect a DCI format 1_0 with CRC scrambled by a corresponding MsgB-RNTI during a window controlled by higher layers, e.g., described in 3GPP TS 38.321. The window, in one embodiment, starts at the first symbol of the earliest CORESET the UE is configured to receive PDCCH for Type1-PDCCH CSS set that is at least one symbol, after the last symbol of the PUSCH occasion corresponding to the PRACH transmission, where the symbol duration corresponds to the SCS for Type1-PDCCH CSS set. The length of the window in number of slots, in one embodiment, based on the SCS for Type1-PDCCH CSS set, is provided by msgB-Response Window.

In response to a transmission of a PRACH, in one embodiment, if the PRACH preamble is not mapped to a valid PUSCH occasion, a UE attempts to detect a DCI format 1_0 with CRC scrambled by a corresponding MsgB-RNTI during a window controlled by higher layers, e.g., described in 3GPP TS 38.321. The window, in one embodiment, starts at the first symbol of the earliest CORESET the UE is configured to receive PDCCH for Type1-PDCCH CSS set that is at least one symbol, after the last symbol of the PRACH occasion corresponding to the PRACH transmission, where the symbol duration corresponds to the SCS for Type1-PDCCH CSS set. The length of the window, in one embodiment, in number of slots, based on the SCS for Type1-PDCCH CSS set, is provided by msgB-Response Window.

If the UE, in one embodiment, detects the DCI format 1_0, with CRC scrambled by the corresponding MsgB-RNTI and LSBs of a SFN field in the DCI format 1_0, if applicable, are same as corresponding LSBs of the SFN where the UE transmitted PRACH, and the UE receives a transport block in a corresponding PDSCH within the window, the UE passes the transport block to higher layers. The higher layers indicate to the physical layer an uplink grant if the RAR message(s) is for fallbackRAR and a random access preamble identity (RAPID) associated with the PRACH transmission is identified, or transmission of a PUCCH with HARQ-ACK information having ACK value if the RAR message(s) is for successRAR, where a PUCCH resource for the transmission of the PUCCH is indicated by PUCCH resource indicator field of 4 bits in the successRAR from a PUCCH resource set that is provided by pucch-ResourceCommon, a slot for the PUCCH transmission is indicated by a PDSCH-to-HARQ_feedback timing indicator field of 3 bits in the successRAR having a value k from {1, 2, 3, 4, 5, 6, 7, 8} and, with reference to slots for PUCCH transmission having duration Tₛₗₒₜ, the slot is determined as n+k+Δ, where n is a slot of the PDSCH reception and Δ is defined for PUSCH transmission, e.g., in Table 6.1.2.1.1-5 of 3GPP TS 38.214, the UE does not expect the first symbol of the PUCCH transmission to be after the last symbol of the PDSCH reception by a time smaller than N_{T,1}+0.5 msec where N_{T,1} is the PDSCH processing time for UE processing capability 1, e.g., described in 3GPP TS 38.214, for operation with shared spectrum channel access, a channel access type and CP extension, e.g., described in 3GPP TS 37.213, for a PUCCH transmission is indicated by a ChannelAccess-CPext field in the successRAR, and the PUCCH transmission is with a same spatial domain transmission filter and in a same active UL BWP as a last PUSCH transmission.

The UE, in one embodiment, does not expect to be indicated to transmit the PUCCH with the HARQ-ACK information at a time that is prior to a time when the UE applies a TA command that is provided by the transport block. If the UE does not detect the DCI format 1_0 with CRC scrambled by the corresponding MsgB-RNTI within the window, or if the UE detects the DCI format 1_0 with CRC scrambled by the corresponding MsgB-RNTI within the window and LSBs of a SFN field in the DCI format 1_0, if applicable, are not same as corresponding LSBs of the SFN where the UE transmitted the PRACH, or if the UE does not correctly receive the transport block in the corresponding PDSCH within the window, or if the higher layers do not identify the RAPID associated with the PRACH transmission from the UE, the higher layers can indicate to the physical layer to transmit only PRACH according to Type-1 random access procedure or to transmit both PRACH and PUSCH according to Type-2 random access procedure, e.g., described in 3GPP TS 38.321. If requested by higher layers, in one embodiment, the UE is expected to transmit a PRACH no later than N_{T,1}+0.75 msec after the last symbol of the window, or the last symbol of the PDSCH reception, where N_{T,1} is a time duration of N₁ symbols corresponding to a PDSCH processing time for UE processing capability 1 when additional PDSCH DM-RS is configured. For μ=0, the UE assumes N_{1,0}=14, e.g., as described in 3GPP TS 38.214.

In one embodiment, an SCS for the PUSCH transmission is provided by subcarrierSpacing in BWP-UplinkCommon. A UE transmits PRACH and the PUSCH on a same uplink carrier of a same serving cell.

A UE, in one embodiment, transmits a transport block in a PUSCH scheduled by a RAR UL grant in a corresponding RAR message using redundancy version number 0. If a TC-RNTI is provided by higher layers, the scrambling initialization of the PUSCH corresponding to the RAR UL grant is by TC-RNTI. Otherwise, the scrambling initialization of the PUSCH corresponding to the RAR UL grant is by C-RNTI. Msg3 PUSCH retransmissions, if any, of the transport block, are scheduled by a DCI format 0_0 with CRC scrambled by a TC-RNTI provided in the corresponding RAR message. The UE, in one embodiment, always transmits the PUSCH scheduled by a RAR UL grant without repetitions.

In one embodiment, with reference to slots for a PUSCH transmission scheduled by a RAR UL grant, if a UE receives a PDSCH with a RAR message ending in slot n for a corresponding PRACH transmission from the UE, the UE transmits the PUSCH in slot n+k₂+Δ, where k₂ and Δ are provided, e.g., in 3GPP TS 38.214.

In one embodiment, the UE may assume a minimum time between the last symbol of a PDSCH reception conveying a RAR message with a RAR UL grant and the first symbol of a corresponding PUSCH transmission scheduled by the RAR UL grant is equal to N_{T,1}+N_{T,2}+0.5 msec, where N_{T,1} is a time duration of N₁ symbols corresponding to a PDSCH processing time for UE processing capability 1 when additional PDSCH DM-RS is configured, N_{T,2} is a time duration of N₂ symbols corresponding to a PUSCH preparation time for UE processing capability 1, e.g., described in 3GPP TS 38.214 and, for determining the minimum time, the UE considers that and N₂ correspond to the smaller of the SCS configurations for the PDSCH and the PUSCH. For μ=0, the UE assumes N_{1,0}=14, e.g., described in 3GPP TS 38.214.

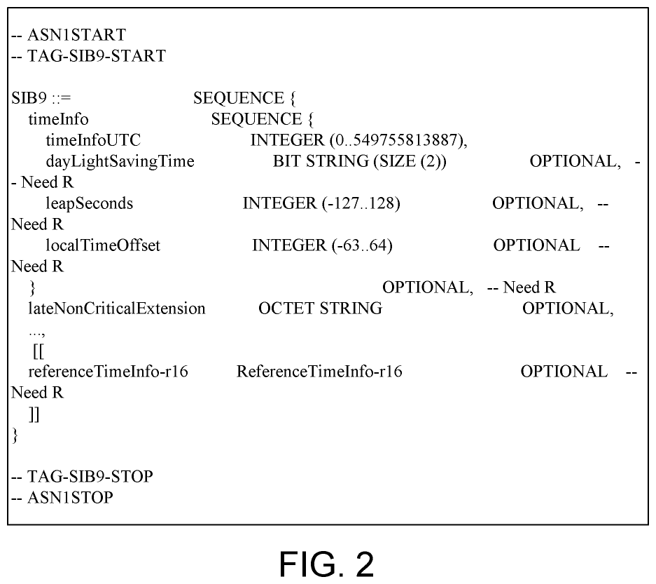

In one embodiment, shown in FIG. 2, SIB9 contains information related to GPS time and Coordinated Universal Time (UTC). The UE may use the parameters provided in this system information block to obtain the UTC, the GPS and the local time. It is noted that, in one embodiment, the UE may use the time information for numerous purposes, possibly involving upper layers e.g. to assist GPS initialisation, to synchronise the UE clock.

dayLightSavingTime

Indicates if and how daylight-saving time (DST) is applied to obtain the local time. The semantics may be the same as the semantics of the Daylight Saving Time IE e.g., in 3GPP TS 24.501 and 3GPP TS 24.008. The first/leftmost bit of the bit string contains the b2 of octet 3 and the second bit of the bit string contains b1 of octet 3 in the value part of the Daylight Saving Time IE, e.g., in 3GPP TS 24.008.

leapSeconds

Number of leap seconds offset between GPS Time and UTC. UTC and GPS time are related i.e., GPS time-leapSeconds=UTC time.

localTimeOffset

Offset between UTC and local time in units of 15 minutes. Actual value=field value*15 minutes. Local time of the day is calculated as UTC time+localTimeOffset.

timeInfoUTC

Coordinated Universal Time corresponding to the SFN boundary at or immediately after the ending boundary of the SI-window in which SIB9 is transmitted. The field counts the number of UTC seconds in 10 ms units since 00:00:00 on Gregorian calendar date 1 Jan. 1900 (midnight between Sunday, Dec. 31, 1899, and Monday, Jan. 1, 1900). See NOTE 1. This field is excluded when determining changes in system information, i.e., changes of timeInfoUTC should neither result in system information change notifications nor in a modification of valueTag in SIB1.

It is noted that, in one embodiment, the UE may use this field together with the leapSeconds field to obtain GPS time as follows: GPS Time (in seconds)=timeInfoUTC (in seconds)−2,524,953,600 (seconds)+leapSeconds, where 2,524,953,600 is the number of seconds between 00:00:00 on Gregorian calendar date 1 Jan. 1900 and 00:00:00 on Gregorian calendar date 6 Jan. 1980 (start of GPS time).

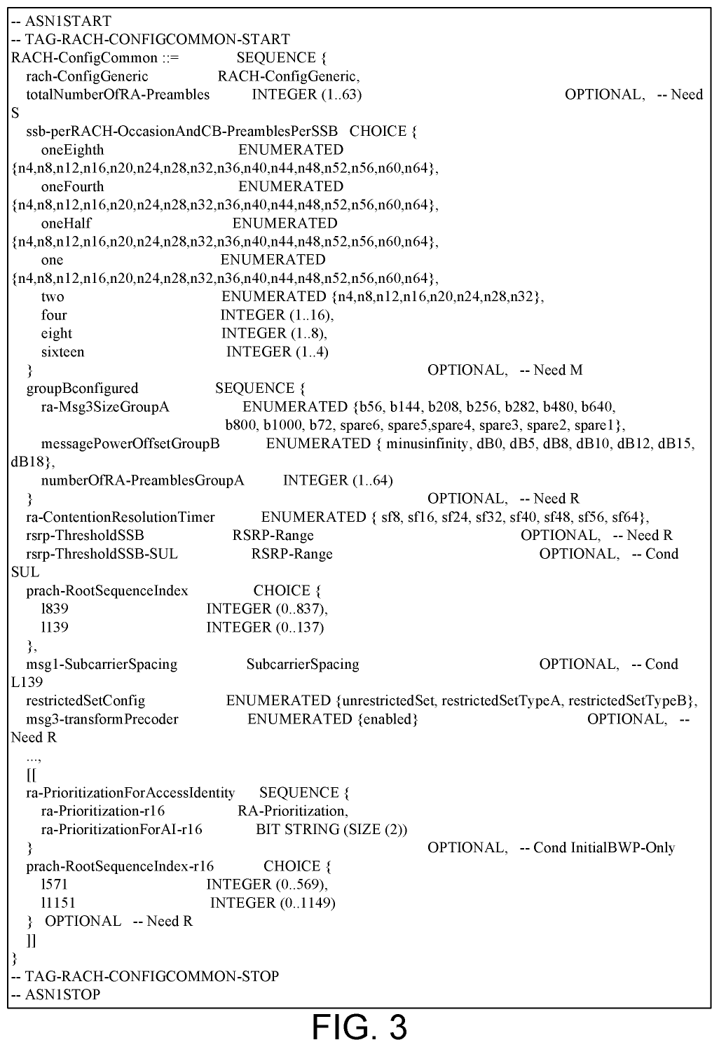

The IE RACH-ConfigCommon, shown in FIG. 3, is used to specify the cell specific random-access parameters.

messagePowerOffsetGroupB

Threshold for preamble selection. Value is in dB. Value minusinfinity corresponds to −infinity Value dB0 corresponds to 0 dB, dB5 corresponds to 5 dB and so on, e.g., described in Clause 5.2.1 of 3GPP TS 38.321.

msg1-SubcarrierSpacing

Subcarrier spacing of PRACH, e.g., as in Clause 5.3.2 of 3GPP TS 38.211. Only the values 15 or 30 kHz (FR1), and 60 or 120 kHz (FR2) are applicable. If absent, the UE applies the SCS as derived from the prach-ConfigurationIndex in RACH-ConfigGeneric, e.g., see tables Table 6.3.3.1-1 and Table 6.3.3.2-2 of 3GPP TS 38.211. The value also applies to contention free random access (RACH-ConfigDedicated), to SI-request and to contention-based beam failure recovery (CB-BFR). But it does not apply for contention free beam failure recovery (CF-BFR).

numberOfRA-PreamblesGroupA

The number of CB preambles per SSB in group A. This determines implicitly the number of CB preambles per SSB available in group B, e.g., Clause 5.1.1 of 3GPP TS 38.321. The setting should be consistent with the setting of ssb-perRACH-OccasionAndCB-PreamblesPerSSB.

prach-RootSequencelndex

PRACH root sequence index, e.g., in Clause 6.3.3.1 of 3GPP TS 38.211. The value range depends on whether L=839 or L=139. The short/long preamble format indicated in this IE should be consistent with the one indicated in prach-ConfigurationIndex in the RACH-ConfigDedicated (if configured). If prach-RootSequenceIndex-r16 is signaled, UE shall ignore the prach-RootSequencelndex (without suffix).

ra-Msg3SizeGroupA

Transport Blocks size threshold in bits below which the UE shall use a contention-based RA preamble of group A, e.g., in Clause 5.1.2 of 3GPP TS 38.321.

rach-ConfigGeneric

RACH parameters for both regular random access and beam failure recovery.

ssb-perRACH-OccasionAndCB-PreamblesPerSSB

The meaning of this field is twofold: the CHOICE conveys the information about the number of SSBs per RACH occasion. Value oneEighth corresponds to one SSB associated with 8 RACH occasions, value oneFourth corresponds to one SSB associated with 4 RACH occasions, and so on. The ENUMERATED part indicates the number of Contention Based preambles per SSB. Value n4 corresponds to 4 Contention Based preambles per SSB, value n8 corresponds to 8 Contention Based preambles per SSB, and so on. The total number of CB preambles in a RACH occasion is given by CB-preambles-per-SSB*max(1, SSB-per-rach-occasion), e.g., in 3GPP TS 38.213.

totalNumberOfRA-Preambles

Total number of preambles used for contention based and contention free 4-step or 2-step random access in the RACH resources defined in RACH-ConfigCommon, excluding preambles used for other purposes (e.g., for SI request). If the field is absent, all 64 preambles are available for RA. The setting should be consistent with the setting of ssb-perRACH-OccasionAndCB-PreamblesPerSSB, i.e., it should be a multiple of the number of SSBs per RACH occasion.

restrictedSetConfig

Configuration of an unrestricted set or one of two types of restricted sets, e.g., in Clause 6.3.3.1 of 3GPP TS 38.211.

In one embodiment of the proposed solution described herein, a UE receives SIB9 from a serving cell and determines first reference GPS time (e.g., GPS time corresponding to an SFN boundary at or immediately after an ending boundary of an SI-window in which SIB9 is transmitted) based on the parameters ‘timeInfoUTC” and ‘leapSeconds’. If the UE is equipped with a GNSS receiver and the GNSS receiver can receive signals from satellites without significant signal quality degradation, the UE can obtain second reference GPS time (e.g., GPS time corresponding to the SFN boundary at or immediately after the ending boundary of the SI-window for SIB9) based on the received GNSS signals.

In one embodiment, the UE can estimate a propagation delay from the serving cell to the UE based on time difference between the first reference GPS time and the second reference GPS time. Further, the UE can autonomously determine a UE-specific TA value appliable to a PRACH preamble transmission(s) in a random access procedure, based on the estimated propagation delay. For example, the UE sets the UE-specific TA value N_{TA} to a value such that N_{TA}·T_{c} corresponds to an estimated round trip time (e.g., two times the estimated propagation delay), and a PRACH preamble transmission timing on a particular PRACH occasion is (N_{TA}+N_{TA,offset}·T_{c} ahead of a corresponding DL timing of the particular PRACH occasion.

In another implementation, a UE receives an indication of a common (e.g., cell-specific) TA value and applies the indicated common TA value to determine a PRACH preamble transmission timing. In one example, the common TA value is included in a cell-specifically configured TA offset N_{TA,offset}. The RRC parameter n-TimingAdvanceOffset-r17 that overrides n-TimingAdvanceOffset, if configured, may include a much larger value, e.g., N_{TA,offset}=19660800 for a serving satellite with 1500 km altitude. The PRACH preamble transmission timing on a particular PRACH occasion is determined as N_{TA,offset}·T_{c} ahead of a corresponding DL timing of the PRACH occasion. In another example, the common TA value N_{TA,common} is indicated in a separate RRC parameter n-TimingAdvanceCommon. The PRACH preamble transmission timing on a particular PRACH occasion is determined as (N_{TA,common} N_{TA,offset})·T_{c} ahead of a corresponding DL timing of the PRACH occasion.

In the above-mentioned implementation options, for a 2-step random access procedure (e.g., Type-2 random access procedure of 3GPP TS 38.213), a MsgA PUSCH transmission timing is also determined similar to a PRACH preamble transmission timing. That is, the MsgA PUSCH transmission timing on a particular MsgA PUSCH occasion is determined as (N_{TA}+N_{TA,offset})·T_{c}, N_{TA,offset}·T_{c}, or (N_{TA,common}+N_{TA,offset})·T_{c} ahead of a corresponding DL timing of the particular MsgA PUSCH occasion, according to the different implementation options described above.

The parameter N_{TA} may be different from N_{TA} in legacy terrestrial cellular systems in terms of value range or bit-width as well as how it may appear in the standard specifications. For example, a value of round-trip delay may appear as:

N_{TA1}·Tₓ+N_{TA2}·T_{c}, where Tₓ=M·T_{c}

In this example, N_{TA}=N_{TA1}·M+N_{TA2}. A value of M may be determined by the specification or the network (for example broadcast in a SIB).

The range or bit-width of n-TimingAdvanceOffset-r17 or n-TimingAdvanceCommon and their interpretation may be different from those of n-TimingAdvanceOffset. For example, n-TimingAdvanceOffset-r17 or n-TimingAdvanceCommon may comprise only a number of significant bits of a timing advance parameter, in which case the omitted least significant bits can be set to zero by the UE; or otherwise, the parameter may represent a timing advance value in a coarse unit Tₓ=M·T_{c}, where a value of M may be determined by the specification or the network (for example broadcast in a SIB).

Regarding the initiation of a random access procedure, e.g., according to 3GPP TS 38.321, a UE is configured with an RRC parameter timeAlignmentTimer per timing advance group (TAG) which controls how long a MAC entity of the UE considers at least one serving cell belonging to an associated TAG to be uplink time aligned. When the UE receives a Timing Advance Command MAC CE, Absolute Timing Advance Command MAC CE, or a Timing Advance Command in a Random Access Response message associated with a particular TAG, the UE applies the Timing Advance Command and starts or restarts a timeAlignmentTimer for the associated TAG.

If a timeAlignmentTimer associated with a primary TAG (PTAG) expires, in one embodiment, a UE flushes all HARQ buffers for all serving cells, releases PUCCH and SRS for all serving cells, if configured, clears any configured downlink assignments and configured uplink grants, clears any PUSCH resource for semi-persistent CSI reporting, considers all running timeAlignmentTimers as expired, and maintains N_{TA} of all TAGs. If a timeAlignmentTimer associated with a secondary TAG (STAG) expires or is considered as expired due to an uplink transmission timing difference between TAGs larger than a certain value, the UE takes similar actions (i.e. flushing HARQ buffers and releasing configured resources) for all serving cells belonging this TAG and maintains N_{TA} of this TAG.

In one embodiment, e.g., according to 3GPP TS 38.321, a UE shall not perform any uplink transmission on a serving cell except a random access preamble and MsgA transmission when a timeAlignmentTimer associated with a TAG to which this serving cell belongs is not running. Furthermore, when a timeAlignmentTimer associated with a PTAG is not running, the UE shall not perform any uplink transmission on any serving cell except a random access preamble and MsgA transmission on a special cell (“SpCell”).

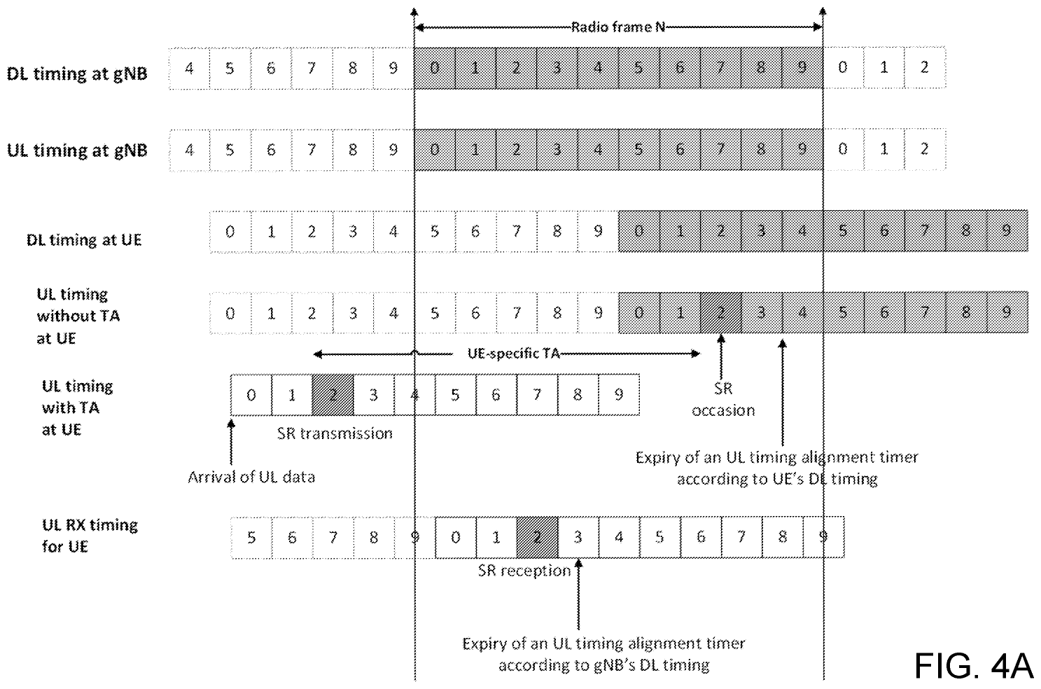

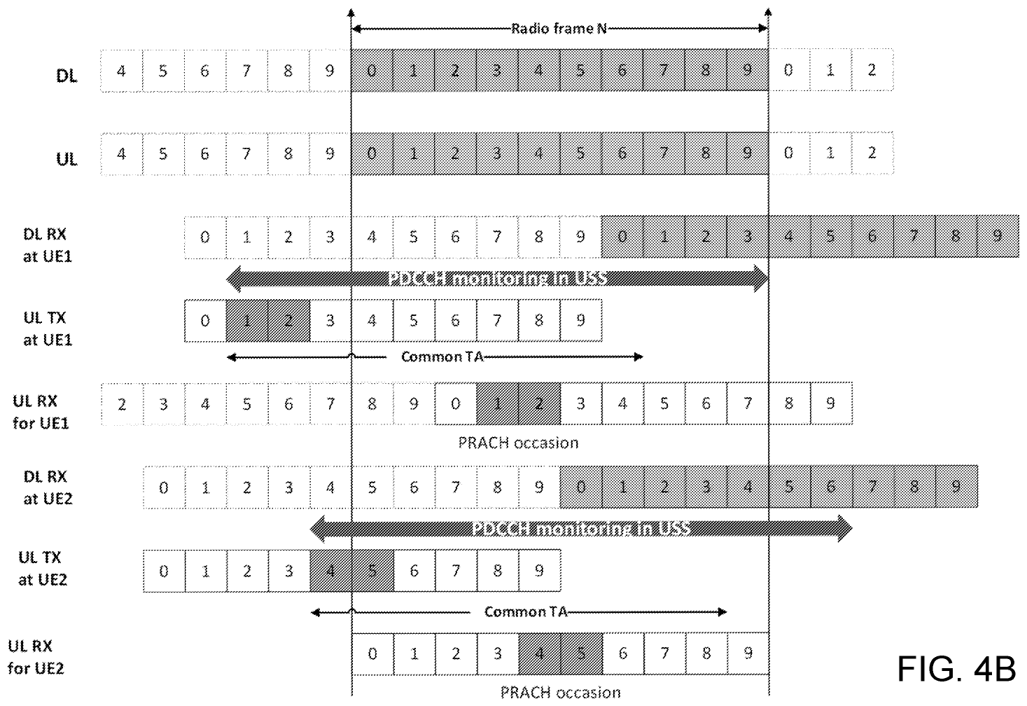

In NTNs, in one embodiment, due to a long round trip time and accordingly a large TA value, a timeAlignmentTimer of a particular TAG may expire while a UE is waiting for an uplink (“UL”) grant after transmitting a scheduling request on a configured PUCCH resource for Scheduling Request (“SR”). In some cases, a network entity (e.g., gNB) may not have enough time to transmit a TA command upon reception of SR, as shown in FIG. 4A.

In one embodiment, a UE in an RRC_CONNECTED state initiates a random access procedure for a TAG for a potential expiry of an UL timing alignment timer upon arrival of UL data (e.g., upon UL data available to a MAC entity), if receiving an implicit or explicit indication(s) that a serving cell of the TAG is an NTN cell and/or if an early initiation of a random access procedure is implicitly or explicitly configured. The UE may further receive information of a timer value at which the UE initiates the random access procedure instead of transmitting a SR upon arriving UL data.

In one example of the above embodiment, the UE initiates the random access procedure in the serving cell of the TAG, if a start time of the earliest SR resource among SR resources, where the UE can transmit the SR with a timing advance upon arrival of UL data, is on or after an expiry of a timeAlignmentTimer of the TAG when the timing advance not being applied. The UE transmits the SR, if the start time of the earliest SR resource among the SR resources, where the UE can transmit the SR with the timing advance upon arrival of the UL data, is before the expiry of the timeAlignmentTimer of the TAG when the timing advance not being applied.

In another example of the above embodiment, the UE initiates a random access procedure in the serving cell of the TAG, if a start time of an SR transmission on the earliest SR resource among SR resources, where the UE can transmit the SR with a timing advance upon arrival of UL data, is on or after a time instance determined by a configured time advance with respect to an expiry of a timeAlignmentTimer of the TAG. The UE transmits the SR, if the start time of the SR transmission on the earliest SR resource among the SR resources, where the UE can transmit the SR with the timing advance upon arrival of the UL data, is before the time instance determined by the configured time advance with respect to the expiry of the timeAlignmentTimer of the TAG.

In another embodiment, a UE initiates a random access procedure for a TAG for a potential Scheduling Request (“SR”) failure, if receiving an implicit or explicit indication(s) that a serving cell of the TAG is an NTN cell and/or that an early initiation of a random access procedure is configured. The UE may further receive information of a timer value at which the UE initiates the random access procedure when a sr-ProhibitTimer is not running, at least one SR is pending, and the number of SR transmissions of a particular SR configuration (i.e. SR COUNTER) is less than the maximum configured number of SR transmissions.

In an example, a UE initiates a random access procedure instead of transmitting a SR in a serving cell of a particular TAG, if a start time of an SR transmission on the earliest SR resource among SR resources, where the UE can transmit the SR with a timing advance when a sr-ProhibitTimer is not running, at least one SR is pending, and the number of SR transmissions of a particular SR configuration (e.g., SR COUNTER) is less than the maximum configured number of SR transmissions, is on or after a time instance determined by a configured time advance with respect to an expiry of a timeAlignmentTimer of the particular TAG. The UE transmits the SR, if the start time of the SR transmission on the earliest SR resource among the SR resources, where the UE can transmit the SR with the timing advance when the sr-ProhibitTimer is not running, the at least one SR is pending, and the number of SR transmissions of a particular SR configuration (e.g., SR COUNTER) is less than the maximum configured number of SR transmissions, is before the time instance determined by the configured time advance with respect to the expiry of the timeAlignmentTimer of the particular TAG.

In other embodiments, a UE transmits an SR, upon arrival of UL data, on an active UL BWP of a serving cell of a particular TAG, as long as a start time of the earliest possible SR transmission (according to SR configurations and a triggered SR) with a timing advance being applied is before an expiry of a timeAlignmentTimer of the particular TAG.

Regarding PDCCH monitoring with initiation of a random access procedure, in one embodiment, a UE in an RRC_CONNECTED state configured with at least one UE-specific search space (“US S”), upon initiation of a random access procedure for a first timing advance group (“TAG”), transmits a PRACH on a PRACH occasion of an active UL bandwidth part (“BWP”) of a first serving cell, with a timing advance value (including a cell-specifically configured UL timing offset with respect to DL timing) larger than a first duration.

In one embodiment, the UE determines whether to monitor PDCCH on at least one configured PDCCH monitoring occasion of the at least one USS at least until a first time instance, while the random access procedure is on-going, wherein the at least one USS is not a search space set for receiving a response to a beam failure recovery request (e.g., search space set provided by recoverySearchSpaceId). The UE, in one embodiment, monitors PDCCH or does not monitor PDCCH on the at least one configured PDCCH monitoring occasion of the at least one USS during a time interval from a start of the PRACH transmission to the first time instance, based on the determination.

In an example, the first duration is a multiple of a DL slot duration, where the DL slot duration is determined based on a DL subcarrier spacing in an active DL BWP of the first serving cell. In another example, the first time instance is earlier than or at a start of a RAR reception window. In yet another example, the first time instance is when an UL timing alignment timer (e.g., timeAlignmentTimer) expires.

In one implementation, the UE continues monitoring PDCCH on the at least one configured PDCCH monitoring occasion of the at least one USS until the first time instance, if at least one of following conditions is met: the first duration is larger than a predefined or configured threshold value; an implicit or explicit indication(s) that the serving cell is an NTN cell is received; an early initiation of a random access procedure is configured; and an explicit or implicit configuration for continued PDCCH monitoring is received.

In NTNs, in one embodiment, a large TA value may be applied to a PRACH transmission to compensate a large DL propagation delay from an acquired DL timing and to pre-compensate a large UL propagation delay in a PRACH delivery. Furthermore, in one embodiment, a time offset may be applied to a starting time of a RAR window (e.g., the RAR window starts at the earliest symbol of the earliest CORESET a UE is configured to receive PDCCH for Type1-PDCCH CSS set, which is at least one symbol after the last symbol of the PRACH occasion) by considering the large UL propagation delay in the PRACH delivery and a large DL propagation delay in corresponding Msg2/MsgB delivery.

Thus, a long time gap from a start of PRACH transmission to a start of the RAR window may be expected. For example, for a serving satellite with 1500 km altitude, a common TA of 10 ms may be applied to the PRACH transmission and the timing offset of 10 ms may be applied to the start time of the RAR window. These may lead to at least a total duration of a sum of 10 ms, a PRACH preamble duration, and one symbol duration (based on the SCS for Type1-PDCCH CSS set) for the time gap from the start of PRACH transmission to the start of the RAR window, as shown in FIG. 4B.

During the above identified time gap from the start of PRACH transmission to the start of the RAR window, in one embodiment, it may be beneficial to continue monitoring PDCCH for a UE-specific search space set. For example, if a random access procedure is triggered by events such as a potential SR failure and/or a potential expiry of an UL timing alignment timer upon arrival of UL data (e.g., the UE transmits a random access preamble before a timeAlignmentTimer expires), the UE may continue monitoring PDCCH for the UE-specific search space set, even after the PRACH transmission, in order to receive an UL grant in response to a previously transmitted SR and/or to receive a TA command that makes the UE restart the UL timing alignment timer before the expiry.

In another embodiment, when a UE continues monitoring PDCCH, after initiating a random access procedure and transmitting a PRACH preamble, on at least one configured PDCCH monitoring occasion of at least one USS until a first time instance, the UE determines whether to start an RAR timer and monitor PDCCH within an RAR window, based on detected DCI formats in a time interval from a start of the PRACH transmission to the first time instance and/or based on a received configuration.

In one implementation, if the UE detects at least one DCI format associated with receiving a TA command and at least one DCI format associated with receiving an UL grant in the at least one USS before a start of an RAR window associated with the transmitted PRACH preamble, the UE considers the initiated random access procedure as being successfully completed and does not start a RAR window timer (e.g., ra-Response Window or msgB-ResponseWindow) and does not monitor PDCCH in a Type1-PDCCH CSS set (i.e. PDCCH with CRC scrambled with RA-RNTI in a 4-step random access procedure or PDCCH with CRC scrambled with MsgB-RNTI in a 2-step random access procedure) in response to the PRACH preamble transmission.

In another implementation, if the UE detects at least one DCI format associated with receiving a TA command but does not detect at least one DCI format associated with receiving an UL grant in the at least one USS before the start of the RAR window and if the UE has a pending SR and/or a pending UL data, the UE monitors PDCCH in the Type1-PDCCH CSS set to receive the UL grant for Msg3 transmission and additionally monitors PDCCH with CRC scrambled with C-RNTI for the case of 2-step random access within the RAR window. In one example, the UE transmits a C-RNTI MAC CE and a BSR MAC CE in the UL grant for Msg3 transmission.

In yet another implementation, if the UE does not detect at least one DCI format associated with receiving a TA command in the at least one USS before the start of the RAR window and if the timeAlignmentTimer associated with this TAG is not running, the UE monitors PDCCH in the Type1-PDCCH CSS set to receive a TA command and additionally monitors PDCCH with CRC scrambled with C-RNTI for the case of 2-step random access within the RAR window.

Regarding timing for PRACH preamble retransmission, in one embodiment, if the UE does not detect the DCI format 1_0 with CRC scrambled by the corresponding RA-RNTI within the window, or if the UE detects the DCI format 1_0 with CRC scrambled by the corresponding RA-RNTI within the window and LSBs of a SFN field in the DCI format 1_0, if included and applicable, are not same as corresponding LSBs of the SFN where the UE transmitted PRACH, or if the UE does not correctly receive the transport block in the corresponding PDSCH within the window, or if the higher layers do not identify the RAPID associated with the PRACH transmission from the UE, the higher layers can indicate to the physical layer to transmit a PRACH.

If requested by higher layers, in one embodiment, the UE is expected to transmit a PRACH with a timing advance no later than N_{T,1}1+0.75 msec after the last symbol of the window, or the last symbol of the PDSCH reception, where N_{T,1} is a time duration of N₁ symbols corresponding to a PDSCH processing time for UE processing capability 1 assuming μ corresponds to the smallest SCS configuration among the SCS configurations for the PDCCH carrying the DCI format 1_0, the corresponding PDSCH when additional PDSCH DM-RS is configured, and the corresponding PRACH. For μ=0, the UE assumes N_{1,0}=14. For a PRACH transmission using 1.25 kHz or 5 kHz SCS, the UE determines N₁ assuming SCS configuration μ=0.

Regarding timing for Msg3 transmission, in one embodiment, with reference to slots for a PUSCH transmission scheduled by a RAR UL grant, if a UE receives a PDSCH with a RAR message ending in slot n for a corresponding PRACH transmission from the UE, the UE transmits the PUSCH in slot n+k₂+Δ+k_{offset}, where k₂ and Δ are provided in and k_{offset} is an offset in terms of a number of slots associated with the maximum TA value which is cell-specifically configured, is UE-specifically configured, or comprises at least one cell-specific parameter and at least one UE-specific parameter. For example, a slot for the PUSCH transmission is determined as n+k₂+Δ+k_{offset}, n being an ending slot of a physical downlink shared channel with the random access response message, k₂ being a part of time-domain scheduling information included in the random access response message, Δ being a predefined subcarrier spacing specific slot delay, k_{offset} being an offset in terms of a number of slots associated with a maximum timing advance value that is at least one of cell-specifically configured, UE-specifically configured, and comprises at least one cell-specific parameter and at least one UE-specific parameter.

The UE may assume a minimum time between the last symbol of a PDSCH reception conveying a RAR message with a RAR UL grant and the earliest symbol of a corresponding PUSCH transmission scheduled by the RAR UL grant with a timing advance is equal to N_{T,1}+N_{T,2}+0.5 msec, where N_{T,1} is a time duration of N₁ symbols corresponding to a PDSCH processing time for UE processing capability 1 when additional PDSCH DM-RS is configured, N_{T,2} is a time duration of N₂ symbols corresponding to a PUSCH preparation time for UE processing capability 1, e.g., in 3GPP TS 38.214, and, for determining the minimum time, the UE considers that N₁ and N₂ correspond to the smaller of the SCS configurations for the PDSCH and the PUSCH. For μ=0, the UE assumes N_{1,0}=14, e.g., described in 3GPP TS 38.214.

Regarding timing for HARQ-ACK feedback to MsgB successRAR, in one embodiment, if the UE detects the DCI format 1_0, with CRC scrambled by the corresponding MsgB-RNTI and LSBs of a SFN field in the DCI format 1_0, if applicable, are same as corresponding LSBs of the SFN where the UE transmitted PRACH, and the UE receives a transport block in a corresponding PDSCH within the window, the UE passes the transport block to higher layers. The higher layers indicate to the physical layer, in one embodiment, transmission of a PUCCH with HARQ-ACK information having ACK value if the RAR message(s) is for successRAR, where a slot for the PUCCH transmission is indicated by a PDSCH-to-HARQ_feedback timing indicator field of 3 bits in the successRAR having a value k from {1, 2, 3, 4, 5, 6, 7, 8} and, with reference to slots for PUCCH transmission having duration Tₛₗₒₜ, the slot is determined as n+k+Δ+k_{offset}, where n is a slot of the PDSCH reception, k_{offset} is an offset in terms of a number of slots associated with the maximum TA value which is cell-specifically configured, is UE-specifically configured, or comprises at least one cell-specific parameter and at least one UE-specific parameter, and Δ is predefined for PUSCH transmission and the UE does not expect the earliest symbol of the PUCCH transmission with a TA to be after the last symbol of the PDSCH reception by a time smaller than N_{T,1}+0.5 msec where N_{T,1} is the PDSCH processing time for UE processing capability 1.

For example, a slot for the HARQ-ACK message transmission is determined as n+k+Δ+k_{offset}, n being a slot of a physical downlink shared channel (“PDSCH”) of the successRAR message, k being PDSCH-to-HARQ feedback timing information included in the successRAR message, Δ being a predefined subcarrier spacing specific slot delay, and k_{offset} being an offset in terms of a number of slots associated with a maximum timing advance value that is at least one of cell-specifically configured, UE-specifically configured, and comprises at least one cell-specific parameter and at least one UE-specific parameter.

Regarding PRACH preamble transmission timing in PDCCH-ordered random access procedure, in one embodiment, if a UE detects a DCI format initiating a PDCCH-ordered random access procedure, the UE transmits a PRACH preamble on a PRACH occasion with a TA determined based on a signaled common TA value or a GNSS based computed TA value, for which a time between the last symbol of the PDCCH order reception and the earliest symbol of the PRACH transmission with the TA is larger than or equal to N_{T,2}+Δ_{BWPSwitching}+Δ_{Delay}+T_{switch} msec, where N_{T,2} is a time duration of N₂ symbols corresponding to a PUSCH preparation time for UE processing capability 1 assuming μ corresponds to the smallest SCS configuration between the SCS configuration of the PDCCH order and the SCS configuration of the corresponding PRACH transmission, Δ_{BWPSwitching}=0 if the active UL BWP does not change otherwise Δ_{Delay}=0.5 msec for FR1 and Δ_{Delay}=0.25 msec for FR2, and T_{switch} is a switching gap duration. For a PRACH transmission using 1.25 kHz or 5 kHz SCS, the UE determines N₂ assuming SCS configuration μ=0.

Regarding UE TA capability indication, in one embodiment, a UE indicates whether UE employs a GNSS based TA estimate or employs a signaled common TA for a PRACH transmission in a random access procedure. In one implementation, the TA capability information can be included in Msg3 PUSCH or MsgA PUSCH. Based on received UE TA capability information, in one embodiment, a gNB can set an uplink timing alignment timer value (e.g., timeAlignmentTimer) properly for the UE. For example, if the UE indicates that GNSS based TA estimation is feasible at a given time, gNB may configure the UE with a large timeAlignmentTimer value (e.g. 10240 ms). If the UE indicates that the common TA is applied, gNB may configure the UE with a small timeAlignmentTimer value (e.g. 500 ms).

In another embodiment, a UE receives at least two cell-specific uplink time alignment timer parameters/values (e.g., timeAlignmentTimerCommon1, timeAlignmentTimerCommon2) in a system information block or in a dedicated RRC message configuring a serving cell, where a first parameter/value is associated with use of a GNSS based TA estimate and a second parameter/value is associated with use of a common (e.g., cell-specific) TA value. When the UE has not been configured with a UE-specific uplink time alignment timer parameter (e.g., timeAlignmentTimer), the UE can choose which cell-specific uplink time alignment timer parameter/value to use based on how an initial TA value is determined (i.e. GNSS based TA estimate vs common TA value).

Regarding configuration of PRACH preamble sequences, in one embodiment, for a given random access configuration, a UE receives two or more PRACH preamble root sequence indices (e.g., prach-RootSequencelndex1 and prach-RootSequencelndex2), wherein adjacent consecutive PRACH occasions in a time domain for the random access configuration are associated with different PRACH preamble root sequence indices. That is, different sets of PRACH preamble sequences are used on the adjacent consecutive PRACH occasions in the time domain.

As shown in FIG. 4B, in one embodiment, although UE1 and UE2 select different PRACH occasions for PRACH preamble transmissions, gNB may simultaneously receive the PRACH preambles of the different PRACH occasions from the different UEs. This may result in ambiguity in timing estimation and preamble sequence detection. To mitigate the impact of interference from adjacent PRACH occasions (e.g., to avoid timing estimation ambiguity), different preamble sequence sets can be employed for adjacent PRACH occasions.

In the embodiments of this disclosure, a UE can further receive information of a TA drift rate (or can estimate the TA drift) and autonomously adjust a TA value, irrespective of whether an uplink timing alignment timer is running or not.

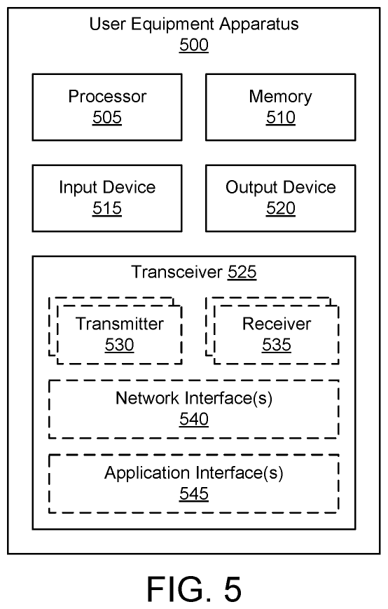

FIG. 5 depicts a user equipment apparatus 500 that may be used for random access procedure in a non-terrestrial network, according to embodiments of the disclosure. In various embodiments, the user equipment apparatus 500 is used to implement one or more of the solutions described above. The user equipment apparatus 500 may be one embodiment of the remote unit 105 and/or the UE 205, described above. Furthermore, the user equipment apparatus 500 may include a processor 505, a memory 510, an input device 515, an output device 520, and a transceiver 525.

In some embodiments, the input device 515 and the output device 520 are combined into a single device, such as a touchscreen. In certain embodiments, the user equipment apparatus 500 may not include any input device 515 and/or output device 520. In various embodiments, the user equipment apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. In some embodiments, the transceiver 525 communicates with one or more cells (or wireless coverage areas) supported by one or more base units 121. In various embodiments, the transceiver 525 is operable on unlicensed spectrum. Moreover, the transceiver 525 may include multiple UE panel supporting one or more beams. Additionally, the transceiver 525 may support at least one network interface 540 and/or application interface 545. The application interface(s) 545 may support one or more APIs. The network interface(s) 540 may support 3GPP reference points, such as Uu, N1, PCS, etc. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525. In certain embodiments, the processor 505 may include an application processor (also known as “main processor”) which manages application-domain and operating system (“OS”) functions and a baseband processor (also known as “baseband radio processor”) which manages radio functions.

In one embodiment, the processor 505 determines one or more transmission timings associated with a random access procedure, each transmission timing determined based on each transmission slot and a timing advance value, for transmitting messages between the UE and a mobile wireless communication network, the mobile wireless communication network comprising a non-terrestrial network (“NTN”), each transmission slot determined by applying a configured slot offset, the configured slot offset applied to adjust for a round trip time within the NTN. In one embodiment, the transceiver 525 transmits one or more messages during the random access procedure based on the determined one or more transmission timings.

In one embodiment, the one or more messages comprises a physical random access channel (“PRACH”) preamble message that is retransmitted with the timing advance value, the timing advance value applied to adjust for the round trip time within the NTN. In one embodiment, the one or more messages comprises a physical uplink shared channel (“PUSCH”) message that is transmitted in response to a random access response (“RAR”) message, wherein the transmission slot is determined at least based on an ending slot of a physical downlink channel including scheduling information for the PUSCH, time-domain scheduling information for the PUSCH, and the configured slot offset.

In one embodiment, the PUSCH message transmission is a PUSCH transmission scheduled by a RAR uplink (“UL”) grant included in the RAR message, and wherein a minimum time between a last symbol of a physical downlink shared channel (“PDSCH”) reception conveying the RAR message and an earliest symbol of the PUSCH transmission scheduled by the RAR UL grant with the timing advance value is equal to N_{T,1}+N_{T,2}+0.5 msec, where N_{T,1} is a time duration corresponding to a PDSCH processing time and N_{T,2} is a time duration corresponding to a PUSCH preparation time.

In one embodiment, the one or more messages comprises a hybrid automatic repeat request-acknowledgement (“HARQ-ACK”) message that is transmitted in response to a success random access response (“successRAR”) message, wherein the transmission slot is determined at least based on a slot of a physical downlink shared channel (“PDSCH”) with the successRAR message, PDSCH-to-HARQ feedback timing information included in the successRAR message, and the configured slot offset.

In one embodiment, an earliest symbol of a physical uplink control channel (“PUCCH”) transmission conveying the HARQ-ACK message with the timing advance value is after a last symbol of the PDSCH reception by a time equal to or larger than N_{T,1}+0.5 msec where N_{T,1} is a time duration corresponding to a PDSCH processing time.

In one embodiment, the transceiver 525 transmits a physical random access channel (“PRACH”) preamble on a PRACH occasion with a timing advance that is determined based on at least one of a signaled common timing advance value and a global navigation satellite system (“GNSS”) based computed timing advance value.

In one embodiment, a time between the last symbol of a physical downlink control channel (“PDCCH”) order reception and an earliest symbol of the PRACH transmission with the timing advance is larger than or equal to N_{T,2}+Δ_{BWPSwitching}+Δ_{Delay}+T_{switch} msec, N_{T,2} being a PUSCH preparation time, Δ_{BWPSwitching} being a bandwidth part switching delay, Δ_{Delay} being a predefined delay specific to a frequency range, and T_{switch} being a switching gap duration.

In one embodiment, the processor 505 initiates the random access procedure for expiry of an uplink timing alignment timer, in response to receiving uplink data and in response to determining that the mobile wireless communication network comprises an NTN.

In one embodiment, the processor 505 initiates the random access procedure in response to a scheduling request (“SR”) failure. In one embodiment, the transceiver 525 transmits a scheduling request (“SR”) on an active uplink bandwidth part (“BWP”) in response to a start time of an earliest possible SR transmission with the timing advance value applied being prior to an expiry of a timing alignment timer.

In one embodiment, the processor 505 determines whether to monitor a physical downlink control channel (“PDCCH”) on at least one configured PDCCH monitoring occasion of an at least one UE-specific search space (“US S”) at least until a first time instance, while the random access procedure is on-going.

In one embodiment, the processor 505 determines that the random access procedure is complete in response to detecting at least one downlink control information (“DCI”) format associated with receiving a timing advance command and at least one DCI format associated with receiving an uplink (“UL”) grant in the at least one USS before a start of a random access response (“RAR”) window associated with the transmitted physical random access channel (“PRACH”) preamble.

In one embodiment, the transceiver 525 receives a scheduling request (“SR”) configuration. In one embodiment, the processor 505 identifies a SR resource based on the received SR configuration upon arrival of uplink data. In one embodiment, the uplink data is associated with the received SR configuration and the SR resource is an earliest available SR resource for a potential SR transmission with a timing advance after the arrival of the uplink data.

In one embodiment, the processor 505 determines whether to transmit a SR on the SR resource and initiates a random access procedure when determining not to transmit the SR on the SR resource. In one embodiment, the processor 505 initiates the random access procedure while an uplink timing alignment timer at the UE is running.

In one embodiment, the uplink timing alignment timer is a first uplink timing alignment timer. In one embodiment, the transceiver 525 receives information of a second uplink timing alignment timer, where the second uplink timing alignment timer is smaller than the first uplink timing alignment timer. In one embodiment, the processor 505 determines not to transmit the SR on the SR resource when the potential SR transmission with the timing advance ends after an expiry of the second uplink timing alignment timer.

In one embodiment, the uplink timing alignment timer is a first uplink timing alignment timer. In one embodiment, the transceiver 525 receives information of a second uplink timing alignment timer, where the second uplink timing alignment timer is smaller than the first uplink timing alignment timer. In one embodiment, the processor 505 determines not to transmit the SR on the SR resource when the potential SR transmission without the timing advance ends after an expiry of the second uplink timing alignment timer.

In one embodiment, the processor 505 determines not to transmit the SR on the SR resource when the potential SR transmission without the timing advance ends after an expiry of the uplink timing alignment timer. In one embodiment, the transceiver 525 receives at least one UE-specific PDCCH search space configuration and transmits a PRACH preamble upon the initiation of the random access procedure. In one embodiment, the processor 505 performs PDCCH monitoring until a first time instance after transmitting the PRACH preamble based on the at least one UE-specific PDCCH search space configuration.

In one embodiment, the first time instance is determined based on a start time of a random access response window. In one embodiment, the first time instance is determined based on a time instance when the uplink timing alignment timer expires. In one embodiment, the processor 505 determines whether to start a random access response window timer based on the PDCCH monitoring.

In one embodiment, the processor 505 determines not to start the random access response window timer when at least one PDCCH associated with a timing advance command and at least one PDCCH associated with an uplink grant are received based on the PDCCH monitoring.

In one embodiment, the processor 505 determines to start the random access response window timer when at least one PDCCH associated with a timing advance command is not received based on the PDCCH monitoring. In one embodiment, the processor 505 determines to start the random access response window timer when at least one PDCCH associated with an UL grant is not received based on the PDCCH monitoring and when the uplink data is pending.

In one embodiment, the timing advance comprises a UE-specific timing advance and a common timing advance. In one embodiment, the transceiver 525 transmits a PRACH preamble with the timing advance in the random access procedure.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to random access procedure in a non-terrestrial network. For example, the memory 510 may store various parameters, panel/beam configurations, resource assignments, policies, and the like, as described above. In certain embodiments, the memory 510 also stores program code and related data, such as an operating system or other controller algorithms operating on the user equipment apparatus 500.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display separate from, but communicatively coupled to, the rest of the user equipment apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all, or portions of the output device 520 may be integrated with the input device 515. For example, the input device 515 and output device 520 may form a touchscreen or similar touch-sensitive display. In other embodiments, the output device 520 may be located near the input device 515.

The transceiver 525 communicates with one or more network functions of a mobile communication network via one or more access networks. The transceiver 525 operates under the control of the processor 505 to transmit messages, data, and other signals and also to receive messages, data, and other signals. For example, the processor 505 may selectively activate the transceiver 525 (or portions thereof) at particular times in order to send and receive messages.

The transceiver 525 includes at least transmitter 530 and at least one receiver 535. One or more transmitters 530 may be used to provide UL communication signals to a base unit 121, such as the UL transmissions described herein. Similarly, one or more receivers 535 may be used to receive DL communication signals from the base unit 121, as described herein. Although only one transmitter 530 and one receiver 535 are illustrated, the user equipment apparatus 500 may have any suitable number of transmitters 530 and receivers 535. Further, the transmitter(s) 530 and the receiver(s) 535 may be any suitable type of transmitters and receivers. In one embodiment, the transceiver 525 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 525, transmitters 530, and receivers 535 may be implemented as physically separate components that access a shared hardware resource and/or software resource, such as for example, the network interface 540.

In various embodiments, one or more transmitters 530 and/or one or more receivers 535 may be implemented and/or integrated into a single hardware component, such as a multi-transceiver chip, a system-on-a-chip, an ASIC, or other type of hardware component. In certain embodiments, one or more transmitters 530 and/or one or more receivers 535 may be implemented and/or integrated into a multi-chip module. In some embodiments, other components such as the network interface 540 or other hardware components/circuits may be integrated with any number of transmitters 530 and/or receivers 535 into a single chip. In such embodiment, the transmitters 530 and receivers 535 may be logically configured as a transceiver 525 that uses one more common control signals or as modular transmitters 530 and receivers 535 implemented in the same hardware chip or in a multi-chip module.

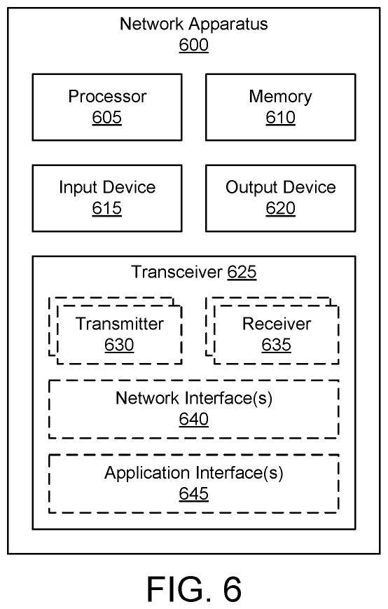

FIG. 6 depicts a network apparatus 600 that may be used for random access procedure in a non-terrestrial network, according to embodiments of the disclosure. In one embodiment, network apparatus 600 may be one implementation of a RAN node, such as the base unit 121, the RAN node 210, or gNB, described above. Furthermore, the base network apparatus 600 may include a processor 605, a memory 610, an input device 615, an output device 620, and a transceiver 625.

In some embodiments, the input device 615 and the output device 620 are combined into a single device, such as a touchscreen. In certain embodiments, the network apparatus 600 may not include any input device 615 and/or output device 620. In various embodiments, the network apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. Here, the transceiver 625 communicates with one or more remote units 105. Additionally, the transceiver 625 may support at least one network interface 640 and/or application interface 645. The application interface(s) 645 may support one or more. The network interface(s) 640 may support 3GPP reference points, such as Uu, N1, N2 and N3. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a CPU, a GPU, an auxiliary processing unit, a FPGA, or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625. In certain embodiments, the processor 805 may include an application processor (also known as “main processor”) which manages application-domain and operating system (“OS”) functions and a baseband processor (also known as “baseband radio processor”) which manages radio function.

In various embodiments, the network apparatus 600 is a RAN node (e.g., gNB) that includes a processor 605 and a transceiver 625. In one embodiment, the processor 605 determines a slot offset, the slot offset applied to adjust for a round trip time within a mobile wireless communication network comprising a non-terrestrial network (“NTN”). In one embodiment, the transceiver 625 transmits the slot offset for communicating messages between a user equipment (“UE”) and a network equipment of the mobile wireless communication network. In one embodiment, the processor 605 further determines one or more transmission timings associated with a random access procedure, each transmission timing determined based on each transmission slot and a timing advance value, each transmission slot determined by applying the slot offset. In one embodiment, the transceiver 625 further receives one or more messages from the UE during the random access procedure based on the determined one or more transmission timings.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to random access procedure in a non-terrestrial network. For example, the memory 610 may store parameters, configurations, resource assignments, policies, and the like, as described above. In certain embodiments, the memory 610 also stores program code and related data, such as an operating system or other controller algorithms operating on the network apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display separate from, but communicatively coupled to, the rest of the network apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all, or portions of the output device 620 may be integrated with the input device 615. For example, the input device 615 and output device 620 may form a touchscreen or similar touch-sensitive display. In other embodiments, the output device 620 may be located near the input device 615.

The transceiver 625 includes at least transmitter 630 and at least one receiver 635. One or more transmitters 630 may be used to communicate with the UE, as described herein. Similarly, one or more receivers 635 may be used to communicate with network functions in the NPN, PLMN and/or RAN, as described herein. Although only one transmitter 630 and one receiver 635 are illustrated, the network apparatus 600 may have any suitable number of transmitters 630 and receivers 635. Further, the transmitter(s) 630 and the receiver(s) 635 may be any suitable type of transmitters and receivers.

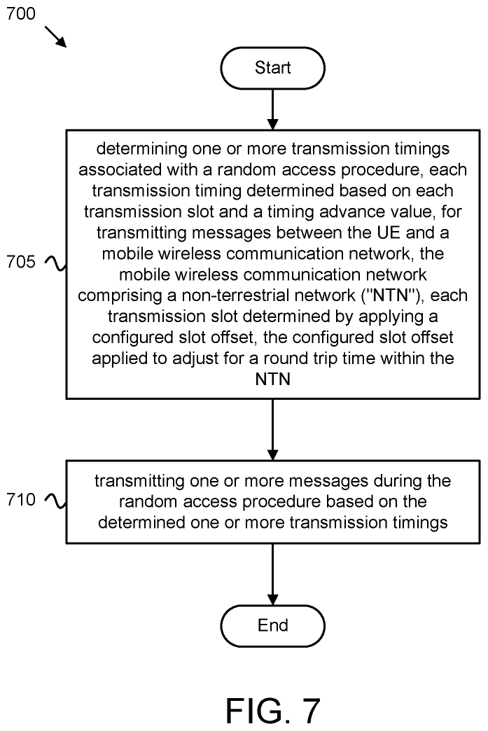

FIG. 7 is a flowchart diagram of a method 700 for random access procedure in a non-terrestrial network. The method 700 may be performed by a UE as described herein, for example, the remote unit 105, the UE 205 and/or the user equipment apparatus 500. In some embodiments, the method 700 may be performed by a processor executing program code, for example, a microcontroller, a microprocessor, a CPU, a GPU, an auxiliary processing unit, a FPGA, or the like.

In one embodiment, the method 700 includes determining 705 one or more transmission timings associated with a random access procedure, each transmission timing determined based on each transmission slot and a timing advance value, for transmitting messages between the UE and a mobile wireless communication network, the mobile wireless communication network comprising a non-terrestrial network (“NTN”), each transmission slot determined by applying a configured slot offset, the configured slot offset applied to adjust for a round trip time within the NTN. In one embodiment, the method 700 includes transmitting 710 one or more messages during the random access procedure based on the determined one or more transmission timings. The method 700 ends.

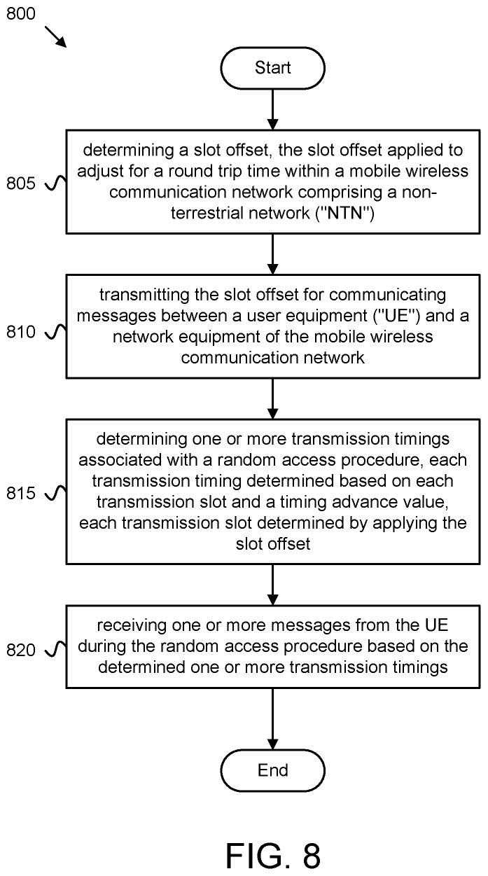

FIG. 8 is a flowchart diagram of a method 800 for random access procedure in a non-terrestrial network. The method 800 may be performed by a network device as described herein, for example, a RAN node, a gNB, and/or the network equipment apparatus 600. In some embodiments, the method 800 may be performed by a processor executing program code, for example, a microcontroller, a microprocessor, a CPU, a GPU, an auxiliary processing unit, a FPGA, or the like.

The method 800 includes determining 805 a slot offset, the slot offset applied to adjust for a round trip time within a mobile wireless communication network comprising a non-terrestrial network (“NTN”). In one embodiment, the method 800 includes transmitting 810 the slot offset for communicating messages between a user equipment (“UE”) and a network equipment of the mobile wireless communication network. In one embodiment, the method 800 includes determining 815 one or more transmission timings associated with a random access procedure, each transmission timing determined based on each transmission slot and a timing advance value, each transmission slot determined by applying the slot offset. The method 800 includes receiving 820 one or more messages from the UE during the random access procedure based on the determined one or more transmission timings The method 800 ends.

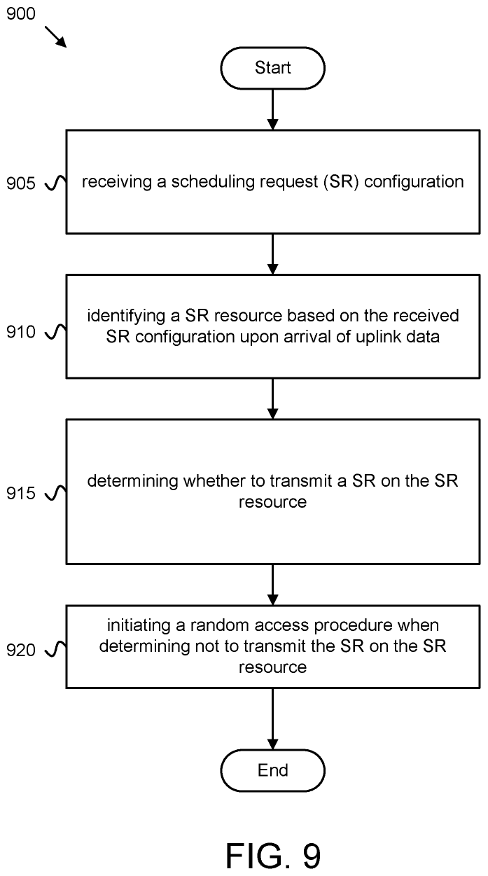

FIG. 9 is a flowchart diagram of a method 900 for random access procedure in a non-terrestrial network. The method 900 may be performed by a UE as described herein, for example, the remote unit 105, the UE 205 and/or the user equipment apparatus 500. In some embodiments, the method 900 may be performed by a processor executing program code, for example, a microcontroller, a microprocessor, a CPU, a GPU, an auxiliary processing unit, a FPGA, or the like.

In one embodiment, the method 900 includes receiving 905 a scheduling request (“SR”) configuration. In one embodiment, the method 900 includes identifying 910 a SR resource based on the received SR configuration upon arrival of uplink data. In one embodiment, the method 900 includes determining 915 whether to transmit a SR on the SR resource. In one embodiment, the method 900 includes initiating 920 a random access procedure when determining not to transmit the SR on the SR resource. The method 900 ends.

Disclosed herein is a first apparatus for random access procedure in anon-terrestrial network. The first apparatus may include a UE as described herein, for example, the remote unit 105, the UE 205 and/or the user equipment apparatus 500. In some embodiments, the first apparatus includes a processor executing program code, for example, a microcontroller, a microprocessor, a CPU, a GPU, an auxiliary processing unit, a FPGA, or the like.

In one embodiment, the first apparatus includes a processor that determines one or more transmission timings associated with a random access procedure, each transmission timing determined based on each transmission slot and a timing advance value, for transmitting messages between the UE and a mobile wireless communication network, the mobile wireless communication network comprising a non-terrestrial network (“NTN”), each transmission slot determined by applying a configured slot offset, the configured slot offset applied to adjust for a round trip time within the NTN. In one embodiment, the first apparatus includes a transceiver that transmits one or more messages during the random access procedure based on the determined one or more transmission timings.

In one embodiment, the one or more messages comprises a physical random access channel (“PRACH”) preamble message that is retransmitted with the timing advance value, the timing advance value applied to adjust for the round trip time within the NTN. In one embodiment, the one or more messages comprises a physical uplink shared channel (“PUSCH”) message that is transmitted in response to a random access response (“RAR”) message, wherein the transmission slot is determined at least based on an ending slot of a physical downlink channel including scheduling information for the PUSCH, time-domain scheduling information for the PUSCH, and the configured slot offset.

In one embodiment, the PUSCH message transmission is a PUSCH transmission scheduled by a RAR uplink (“UL”) grant included in the RAR message, and wherein a minimum time between a last symbol of a physical downlink shared channel (“PDSCH”) reception conveying the RAR message and an earliest symbol of the PUSCH transmission scheduled by the RAR UL grant with the timing advance value is equal to N_{T,1}+N_{T,2}+0.5 msec, where N_{T,1} is a time duration corresponding to a PDSCH processing time and N_{T,2} is a time duration corresponding to a PUSCH preparation time.

In one embodiment, the one or more messages comprises a hybrid automatic repeat request-acknowledgement (“HARQ-ACK”) message that is transmitted in response to a success random access response (“successRAR”) message, wherein the transmission slot is determined at least based on a slot of a physical downlink shared channel (“PDSCH”) with the successRAR message, PDSCH-to-HARQ feedback timing information included in the successRAR message, and the configured slot offset.

In one embodiment, an earliest symbol of a physical uplink control channel (“PUCCH”) transmission conveying the HARQ-ACK message with the timing advance value is after a last symbol of the PDSCH reception by a time equal to or larger than N_{T,1}+0.5 msec where N_{T,1} is a time duration corresponding to a PDSCH processing time.

In one embodiment, the transceiver transmits a physical random access channel (“PRACH”) preamble on a PRACH occasion with a timing advance that is determined based on at least one of a signaled common timing advance value and a global navigation satellite system (“GNSS”) based computed timing advance value.

In one embodiment, a time between the last symbol of a physical downlink control channel (“PDCCH”) order reception and an earliest symbol of the PRACH transmission with the timing advance is larger than or equal to N_{T,2}+Δ_{BWPSwitching}+Δ_{Delay}+T_{switch} msec, N_{T,2} being a PUSCH preparation time, Δ_{BWPSwitching} being a bandwidth part switching delay, Δ_{Delay} being a predefined delay specific to a frequency range, and T_{switch} being a switching gap duration.

In one embodiment, the processor initiates the random access procedure for expiry of an uplink timing alignment timer, in response to receiving uplink data and in response to determining that the mobile wireless communication network comprises an NTN.

In one embodiment, the processor initiates the random access procedure in response to a scheduling request (“SR”) failure. In one embodiment, the transceiver transmits a scheduling request (“SR”) on an active uplink bandwidth part (“BWP”) in response to a start time of an earliest possible SR transmission with the timing advance value applied being prior to an expiry of a timing alignment timer.

In one embodiment, the processor determines whether to monitor a physical downlink control channel (“PDCCH”) on at least one configured PDCCH monitoring occasion of an at least one UE-specific search space (“US S”) at least until a first time instance, while the random access procedure is on-going.

In one embodiment, the processor determines that the random access procedure is complete in response to detecting at least one downlink control information (“DCI”) format associated with receiving a timing advance command and at least one DCI format associated with receiving an uplink (“UL”) grant in the at least one USS before a start of a random access response (“RAR”) window associated with the transmitted physical random access channel (“PRACH”) preamble.

Disclosed herein is a first method for random access procedure in a non-terrestrial network. The first method may be performed by a UE as described herein, for example, the remote unit 105, the UE 205 and/or the user equipment apparatus 500. In some embodiments, the first method may be performed by a processor executing program code, for example, a microcontroller, a microprocessor, a CPU, a GPU, an auxiliary processing unit, a FPGA, or the like.

In one embodiment, the first method includes determining one or more transmission timings associated with a random access procedure, each transmission timing determined based on each transmission slot and a timing advance value, for transmitting messages between the UE and a mobile wireless communication network, the mobile wireless communication network comprising a non-terrestrial network (“NTN”), each transmission slot determined by applying a configured slot offset, the configured slot offset applied to adjust for a round trip time within the NTN. In one embodiment, the first method includes transmitting one or more messages during the random access procedure based on the determined one or more transmission timings.

In one embodiment, the one or more messages comprises a physical random access channel (“PRACH”) preamble message that is retransmitted with the timing advance value, the timing advance value applied to adjust for the round trip time within the NTN. In one embodiment, the one or more messages comprises a physical uplink shared channel (“PUSCH”) message that is transmitted in response to a random access response (“RAR”) message, wherein the transmission slot is determined at least based on an ending slot of a physical downlink channel including scheduling information for the PUSCH, time-domain scheduling information for the PUSCH, and the configured slot offset.

In one embodiment, the PUSCH message transmission is a PUSCH transmission scheduled by a RAR uplink (“UL”) grant included in the RAR message, and wherein a minimum time between a last symbol of a physical downlink shared channel (“PDSCH”) reception conveying the RAR message and an earliest symbol of the PUSCH transmission scheduled by the RAR UL grant with the timing advance value is equal to N_{T,1}+N_{T,2}+0.5 msec, where N_{T,1} is a time duration corresponding to a PDSCH processing time and N_{T,2} is a time duration corresponding to a PUSCH preparation time.

In one embodiment, the one or more messages comprises a hybrid automatic repeat request-acknowledgement (“HARQ-ACK”) message that is transmitted in response to a success random access response (“successRAR”) message, wherein the transmission slot is determined at least based on a slot of a physical downlink shared channel (“PDSCH”) with the successRAR message, PDSCH-to-HARQ feedback timing information included in the successRAR message, and the configured slot offset.

In one embodiment, an earliest symbol of a physical uplink control channel (“PUCCH”) transmission conveying the HARQ-ACK message with the timing advance value is after a last symbol of the PDSCH reception by a time equal to or larger than N_{T,1}+0.5 msec where N_{T,1} is a time duration corresponding to a PDSCH processing time.

In one embodiment, the first method includes transmitting a physical random access channel (“PRACH”) preamble on a PRACH occasion with a timing advance that is determined based on at least one of a signaled common timing advance value and a global navigation satellite system (“GNSS”) based computed timing advance value.

In one embodiment, a time between the last symbol of a physical downlink control channel (“PDCCH”) order reception and an earliest symbol of the PRACH transmission with the timing advance is larger than or equal to N_{T,2}+Δ_{BWPSwitching}+Δ_{Delay}+T_{switch} msec, N_{T,2} being a PUSCH preparation time, Δ_{BWPSwitching} being a bandwidth part switching delay, Δ_{Delay} being a predefined delay specific to a frequency range, and T_{switch} being a switching gap duration.

In one embodiment, the first method includes initiating the random access procedure for expiry of an uplink timing alignment timer, in response to receiving uplink data and in response to determining that the mobile wireless communication network comprises an NTN.

In one embodiment, the first method includes initiating the random access procedure in response to a scheduling request (“SR”) failure. In one embodiment, the transceiver transmits a scheduling request (“SR”) on an active uplink bandwidth part (“BWP”) in response to a start time of an earliest possible SR transmission with the timing advance value applied being prior to an expiry of a timing alignment timer.

In one embodiment, the first method includes determining whether to monitor a physical downlink control channel (“PDCCH”) on at least one configured PDCCH monitoring occasion of an at least one UE-specific search space (“USS”) at least until a first time instance, while the random access procedure is on-going.

In one embodiment, the first method includes determining that the random access procedure is complete in response to detecting at least one downlink control information (“DCI”) format associated with receiving a timing advance command and at least one DCI format associated with receiving an uplink (“UL”) grant in the at least one USS before a start of a random access response (“RAR”) window associated with the transmitted physical random access channel (“PRACH”) preamble.

Disclosed herein is a second apparatus for random access procedure in a non-terrestrial network. The second apparatus may include a network device as described herein, for example, a RAN node, a gNB, and/or the network equipment apparatus 600. In some embodiments, the second apparatus may include a processor executing program code, for example, a microcontroller, a microprocessor, a CPU, a GPU, an auxiliary processing unit, a FPGA, or the like.

In one embodiment, the second apparatus includes a processor that determines a slot offset, the slot offset applied to adjust for a round trip time within a mobile wireless communication network comprising a non-terrestrial network (“NTN”) and a transceiver that transmits the slot offset for communicating messages between a user equipment (“UE”) and a network equipment of the mobile wireless communication network. In one embodiment, the processor further determines one or more transmission timings associated with a random access procedure, each transmission timing determined based on each transmission slot and a timing advance value, each transmission slot determined by applying the slot offset the transceiver further receives one or more messages from the UE during the random access procedure based on the determined one or more transmission timings.

Disclosed herein is a second method for random access procedure in a non-terrestrial network. The second method may be performed by a network device as described herein, for example, a RAN node, a gNB, and/or the network equipment apparatus 600. In some embodiments, the second method may be performed by a processor executing program code, for example, a microcontroller, a microprocessor, a CPU, a GPU, an auxiliary processing unit, a FPGA, or the like.

In one embodiment, the second method includes determining a slot offset, the slot offset applied to adjust for a round trip time within a mobile wireless communication network comprising a non-terrestrial network (“NTN”), transmitting the slot offset for communicating messages between a user equipment (“UE”) and a network equipment of the mobile wireless communication network, determining one or more transmission timings associated with a random access procedure, each transmission timing determined based on each transmission slot and a timing advance value, each transmission slot determined by applying the slot offset, and receiving one or more messages from the UE during the random access procedure based on the determined one or more transmission timings.

Disclosed herein is a third apparatus for random access procedure in a non-terrestrial network. The third apparatus may include a UE as described herein, for example, the remote unit 105, the UE 205 and/or the user equipment apparatus 500. In some embodiments, the third apparatus includes a processor executing program code, for example, a microcontroller, a microprocessor, a CPU, a GPU, an auxiliary processing unit, a FPGA, or the like.

In one embodiment, the third apparatus includes a transceiver that receives a scheduling request (“SR”) configuration. In one embodiment, the third apparatus includes a processor that identifies a SR resource based on the received SR configuration upon arrival of uplink data. In one embodiment, the uplink data is associated with the received SR configuration and the SR resource is an earliest available SR resource for a potential SR transmission with a timing advance after the arrival of the uplink data.

In one embodiment, the processor determines whether to transmit a SR on the SR resource and initiates a random access procedure when determining not to transmit the SR on the SR resource. In one embodiment, the processor initiates the random access procedure while an uplink timing alignment timer at the UE is running.

In one embodiment, the uplink timing alignment timer is a first uplink timing alignment timer. In one embodiment, the transceiver receives information of a second uplink timing alignment timer, where the second uplink timing alignment timer is smaller than the first uplink timing alignment timer. In one embodiment, the processor determines not to transmit the SR on the SR resource when the potential SR transmission with the timing advance ends after an expiry of the second uplink timing alignment timer.

In one embodiment, the uplink timing alignment timer is a first uplink timing alignment timer. In one embodiment, the transceiver receives information of a second uplink timing alignment timer, where the second uplink timing alignment timer is smaller than the first uplink timing alignment timer. In one embodiment, the processor determines not to transmit the SR on the SR resource when the potential SR transmission without the timing advance ends after an expiry of the second uplink timing alignment timer.

In one embodiment, the processor determines not to transmit the SR on the SR resource when the potential SR transmission without the timing advance ends after an expiry of the uplink timing alignment timer. In one embodiment, the transceiver receives at least one UE-specific PDCCH search space configuration and transmits a PRACH preamble upon the initiation of the random access procedure. In one embodiment, the processor performs PDCCH monitoring until a first time instance after transmitting the PRACH preamble based on the at least one UE-specific PDCCH search space configuration.

In one embodiment, the first time instance is determined based on a start time of a random access response window. In one embodiment, the first time instance is determined based on a time instance when the uplink timing alignment timer expires. In one embodiment, the processor determines whether to start a random access response window timer based on the PDCCH monitoring.

In one embodiment, the processor determines not to start the random access response window timer when at least one PDCCH associated with a timing advance command and at least one PDCCH associated with an uplink grant are received based on the PDCCH monitoring.

In one embodiment, the processor determines to start the random access response window timer when at least one PDCCH associated with a timing advance command is not received based on the PDCCH monitoring. In one embodiment, the processor determines to start the random access response window timer when at least one PDCCH associated with an UL grant is not received based on the PDCCH monitoring and when the uplink data is pending.

In one embodiment, the timing advance comprises a UE-specific timing advance and a common timing advance. In one embodiment, the transceiver transmits a PRACH preamble with the timing advance in the random access procedure.

Disclosed herein is a third method for random access procedure in a non-terrestrial network. The third method may be performed by a UE as described herein, for example, the remote unit 105, the UE 205 and/or the user equipment apparatus 500. In some embodiments, the third method may be performed by a processor executing program code, for example, a microcontroller, a microprocessor, a CPU, a GPU, an auxiliary processing unit, a FPGA, or the like.

In one embodiment, the third method includes receiving a scheduling request (“SR”) configuration. In one embodiment, the third method includes identifying a SR resource based on the received SR configuration upon arrival of uplink data. In one embodiment, the uplink data is associated with the received SR configuration and the SR resource is an earliest available SR resource for a potential SR transmission with a timing advance after the arrival of the uplink data.

In one embodiment, the third method includes determining whether to transmit a SR on the SR resource and initiates a random access procedure when determining not to transmit the SR on the SR resource. In one embodiment, the third method includes initiating the random access procedure while an uplink timing alignment timer at the UE is running

In one embodiment, the uplink timing alignment timer is a first uplink timing alignment timer. In one embodiment, the third method includes receiving information of a second uplink timing alignment timer, where the second uplink timing alignment timer is smaller than the first uplink timing alignment timer. In one embodiment, the third method includes determining not to transmit the SR on the SR resource when the potential SR transmission with the timing advance ends after an expiry of the second uplink timing alignment timer.

In one embodiment, the uplink timing alignment timer is a first uplink timing alignment timer. In one embodiment, the third method includes receiving information of a second uplink timing alignment timer, where the second uplink timing alignment timer is smaller than the first uplink timing alignment timer. In one embodiment, the third method includes determining not to transmit the SR on the SR resource when the potential SR transmission without the timing advance ends after an expiry of the second uplink timing alignment timer.

In one embodiment, the third method includes determining not to transmit the SR on the SR resource when the potential SR transmission without the timing advance ends after an expiry of the uplink timing alignment timer. In one embodiment, the third method includes receiving at least one UE-specific PDCCH search space configuration and transmits a PRACH preamble upon the initiation of the random access procedure. In one embodiment, the third method includes performing PDCCH monitoring until a first time instance after transmitting the PRACH preamble based on the at least one UE-specific PDCCH search space configuration.

In one embodiment, the first time instance is determined based on a start time of a random access response window. In one embodiment, the first time instance is determined based on a time instance when the uplink timing alignment timer expires. In one embodiment, the third method includes determining whether to start a random access response window timer based on the PDCCH monitoring.

In one embodiment, the third method includes determining not to start the random access response window timer when at least one PDCCH associated with a timing advance command and at least one PDCCH associated with an uplink grant are received based on the PDCCH monitoring.

In one embodiment, the third method includes determining to start the random access response window timer when at least one PDCCH associated with a timing advance command is not received based on the PDCCH monitoring. In one embodiment, the third method includes determining to start the random access response window timer when at least one PDCCH associated with an UL grant is not received based on the PDCCH monitoring and when the uplink data is pending.

In one embodiment, the timing advance comprises a UE-specific timing advance and a common timing advance. In one embodiment, the third method includes transmitting a PRACH preamble with the timing advance in the random access procedure.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a processor; and
a memory coupled to the processor, the memory comprising instructions that are executable by the processor to cause the apparatus to:
determine one or more transmission timings associated with a random access procedure based on a transmission slot and a timing advance value for transmitting messages within a non-terrestrial network (“NTN”);
adjust the transmission slot by a configured slot offset to adjust for a round trip time within the NTN; and
transmit one or more messages during the random access procedure based on the determined one or more transmission timings.

2. The apparatus of claim 1, wherein the one or more messages comprises a physical random access channel (“PRACH”) preamble message that is retransmitted with the timing advance value, the timing advance value applied to adjust for the round trip time within the NTN.

3. The apparatus of claim 1, wherein the one or more messages comprises a physical uplink shared channel (“PUSCH”) message that is transmitted in response to a random access response (“RAR”) message, wherein the transmission slot is determined at least based on an ending slot of a physical downlink channel including scheduling information for the PUSCH, time-domain scheduling information for the PUSCH, and the configured slot offset.

4. The apparatus of claim 3, wherein the PUSCH message transmission is a PUSCH transmission scheduled by a RAR uplink (“UL”) grant included in the RAR message, and wherein a minimum time between a last symbol of a physical downlink shared channel (“PDSCH”) reception conveying the RAR message and an earliest symbol of the PUSCH transmission scheduled by the RAR UL grant with the timing advance value is equal to N_{T,1}+N_{T,2}+0.5 msec, where N_{T,1} is a time duration corresponding to a PDSCH processing time and N_{T,2} is a time duration corresponding to a PUSCH preparation time.

5. The apparatus of claim 1, wherein the one or more messages comprises a hybrid automatic repeat request-acknowledgement (“HARQ-ACK”) message that is transmitted in response to a success random access response (“successRAR”) message, wherein the transmission slot is determined at least based on a slot of a physical downlink shared channel (“PDSCH”) with the successRAR message, PDSCH-to-HARQ feedback timing information included in the successRAR message, and the configured slot offset.

6. The apparatus of claim 5, wherein an earliest symbol of a physical uplink control channel (“PUCCH”) transmission conveying the HARQ-ACK message with the timing advance value is after a last symbol of the PDSCH reception by a time equal to or larger than N_{T,1}+0.5 msec where N_{T,1} is a time duration corresponding to a PDSCH processing time.

7. The apparatus of claim 1, wherein the transceiver instructions are executable by the processor to cause the apparatus to transmit a physical random access channel (“PRACH”) preamble on a PRACH occasion with a timing advance that is determined based on at least one of a signaled common timing advance value and a global navigation satellite system (“GNSS”) based computed timing advance value.

8. The apparatus of claim 7, wherein a time between the last symbol of a physical downlink control channel (“PDCCH”) order reception and an earliest symbol of the PRACH transmission with the timing advance is larger than or equal to N_{T,2}+Δ_{BWPSwitching}+Δ_{Delay}+T_{switch} msec, N_{T,2} being a PUSCH preparation time, Δ_{BWPSwitching} being a bandwidth part switching delay, Δ_{Delay} being a predefined delay specific to a frequency range, and T_{switch} being a switching gap duration.

9. A method, comprising:
determining one or more transmission timings associated with a random access procedure based on a transmission slot and a timing advance value for transmitting messages within a non-terrestrial network (“NTN”);
adjusting the transmission slot by a configured slot offset to adjust for a round trip time within the NTN; and
transmitting one or more messages during the random access procedure based on the determined one or more transmission timings.

10. The method of claim 9, wherein the one or more messages comprises a physical random access channel (“PRACH”) preamble message that is retransmitted with the timing advance value, the timing advance value applied to adjust for the round trip time within the NTN.

11. The method of claim 9, wherein the one or more messages comprises a physical uplink shared channel (“PUSCH”) message that is transmitted in response to a random access response (“RAR”) message, wherein the transmission slot is determined at least based on an ending slot of a physical downlink channel including scheduling information for the PUSCH, time-domain scheduling information for the PUSCH, and the configured slot offset.

12. The method of claim 11, wherein the PUSCH message transmission is a PUSCH transmission scheduled by a RAR uplink (“UL”) grant included in the RAR message, and wherein a minimum time between a last symbol of a physical downlink shared channel (“PDSCH”) reception conveying the RAR message and an earliest symbol of the PUSCH transmission scheduled by the RAR UL grant with the timing advance value is equal to N_{T,1}+N_{T,2}+0.5 msec, where N_{T,1} is a time duration corresponding to a PDSCH processing time and N_{T,2} is a time duration corresponding to a PUSCH preparation time.

13. The method of claim 9, wherein the one or more messages comprises a hybrid automatic repeat request-acknowledgement (“HARQ-ACK”) message that is transmitted in response to a success random access response (“successRAR”) message, wherein the transmission slot is determined at least based on a slot of a physical downlink shared channel (“PDSCH”) with the successRAR message, PDSCH-to-HARQ feedback timing information included in the successRAR message, and the configured slot offset.

14. The method of claim 13, wherein an earliest symbol of a physical uplink control channel (“PUCCH”) transmission conveying the HARQ-ACK message with the timing advance value is after a last symbol of the PDSCH reception by a time equal to or larger than N_{T,1}+0.5 msec where N_{T,1} is a time duration corresponding to a PDSCH processing time.

15. An apparatus, comprising:
a processor; and
a memory coupled to the processor, the memory comprising instructions that are executable by the processor to cause the apparatus to:
determine a slot offset to adjust for a round trip time within a non-terrestrial network (“NTN”);
transmit the slot offset for communicating messages within the NTN, wherein one or more transmission timings associated with a random access procedure are determined based on a transmission slot and a timing advance value, the transmission slot adjusted by the slot offset to adjust for a round trip time within the NTN; and
receive one or more messages during the random access procedure, wherein the one or more messages are transmitted based on the one or more transmission timings.

16. The apparatus of claim 1, wherein the instructions are executable by the processor to initiate the random access procedure for expiry of an uplink timing alignment timer, in response to arrival of uplink data.

17. The apparatus of claim 16, wherein the instructions are executable by the processor to initiate the random access procedure in response to a scheduling request (“SR”) failure.

18. The apparatus of claim 16, wherein the instructions are executable by the processor to transmit a scheduling request (“SR”) on an active uplink bandwidth part (“BWP”) in response to a start time of an earliest possible SR transmission with the timing advance value applied prior to an expiry of a timing alignment timer.

19. The apparatus of claim 1, wherein the instructions are executable by the processor to monitor a physical downlink control channel (“PDCCH”) on at least one configured PDCCH monitoring occasion of at least one user equipment (“UE”)-specific search space for the apparatus until a first time instance during the random access procedure.

20. The apparatus of claim 19, wherein the instructions are executable by the processor to determine that the random access procedure is complete in response to detecting at least one downlink control information (“DCI”) format associated with receiving a timing advance command and at least one DCI format associated with receiving an uplink grant in the at least one UE-specific search space prior to a start of a random access response (“RAR”) window associated with a transmitted physical random access channel (“PRACH”) preamble.
